(19) United States
(12) Patent Application Publication
(10) Pub. No.: US 2026/0222492 A1
(43) Pub. Date: Jul. 30, 2026

(54) INFORMATION PROCESSING DEVICE, COMMUNICATION DEVICE, INFORMATION PROCESSING METHOD, AND COMMUNICATION METHOD

(71) Applicant: Sony Group Corporation, Tokyo (JP)

(72) Inventor: Yoshiaki NAKA, Kanagawa (JP)

(73) Assignee: Sony Group Corporation, Tokyo (JP)

(21) Appl. No.: 19/146,219

(22) PCT Filed: Jan. 23, 2024
(86) PCT No.: PCT/JP2024/001744

§ 371 Date: Jul. 8, 2025

(30) Foreign Application Priority Data
Feb. 8, 2023 (JP) 2023-017590

(51) Int. Cl. H04M 3/56; G10L 13/02; G10L 15/22; G10L 15/30

(52) U.S. Cl. CPC H04M 3/568; G10L 13/02; G10L 15/22; G10L 15/30; H04M 3/563; H04M 2201/39; H04M 2201/405

(57) ABSTRACT

An information processing system configured to acquire a voice corresponding to a first user of a first communication device in a group call, generate audio data including predetermined content indicating a state of one or more second users that participate in or are to participate in the group call, and output the audio data to at least the first communication device.

### TECHNICAL FIELD

The present disclosure relates to an information processing device, a communication device, an information processing method, and a communication method.

### BACKGROUND ART

The number of opportunities for telephone calls/online meetings (hereinafter, referred to as a group call) held by a large number of people is increasing. In recent years, a group call system having various functions has been developed.

### CITATION LIST

### Patent Literature

PTL 1: JP 2016-533690 A

### SUMMARY OF INVENTION

According to one configuration, the disclosure is directed to an information processing system configured to acquire a voice corresponding to a first user of a first communication device in a group call; generate audio data including predetermined content indicating a state of one or more second users that participate in or are to participate in the group call; and output the audio data to at least the first communication device.

According to another exemplary configuration, the disclosure is directed to an information processing method that includes acquiring a voice corresponding to a first user of a first communication device in a group call; generating audio data including predetermined content indicating a state of one or more second users that participate in or are to participate in the group call; and outputting the audio data to at least the first communication device.

According to another exemplary configuration, the disclosure is directed to one or more non-transitory computer-readable media including computer-program instructions, which when executed by an information processing system, cause the system to acquire a voice corresponding to a first user of a first communication device in a group call; generate audio data including predetermined content indicating a state of one or more second users that participate in or are to participate in the group call; and output the audio data to at least the first communication device.

According to another exemplary configuration, the disclosure is directed to an information processing device configured to capture voice data corresponding to a first user of the information processing device participating in a group call; transmit the captured voice data to a system remote from the information processing device; receive, from the system, audio data including predetermined content indicating a state of one or more second users that participate in or are to participate in the group call; and output the audio data received from the system.

### BRIEF DESCRIPTION OF DRAWINGS

FIG. 1 is a diagram for explaining a problem of the present embodiment.

FIG. 2 is a diagram for explaining a problem of the present embodiment.

FIG. 3 is a diagram for explaining an example of a solution means of the present embodiment.

FIG. 4A is a diagram for explaining another example of the solution means of the present embodiment.

FIG. 4B is a diagram for explaining another example of the solution means of the present embodiment.

FIG. 5 is a diagram illustrating a configuration example of an information processing system according to an embodiment of the present disclosure.

FIG. 6 is a diagram illustrating a specific configuration example of an information processing system.

FIG. 7 is a diagram illustrating a configuration example of a server according to an embodiment of the present disclosure.

FIG. 8 is a diagram illustrating a configuration example of a terminal device according to an embodiment of the present disclosure.

FIG. 9 is a diagram illustrating a configuration example of a group call system according to an embodiment of the present disclosure.

FIG. 10 is a state transition diagram illustrating transition of a user state in a group call.

FIG. 11 is a sequence diagram for describing an outline of an operation of the information processing system.

FIG. 12 is a sequence diagram illustrating an example of initial processing.

FIG. 13 is a sequence diagram illustrating an example of group call participation processing.

FIG. 14 is a sequence diagram illustrating an example of user state update processing.

FIG. 15 is a sequence diagram illustrating an example of user state update processing.

FIG. 16 is a sequence diagram illustrating an example of group call leaving processing.

FIG. 17 is a sequence diagram illustrating an example of end processing.

FIG. 18 is a flowchart illustrating an example of proxy response processing.

### DESCRIPTION OF EMBODIMENTS

Hereinafter, embodiments of the present disclosure will be described in detail with reference to the drawings. Note that, in each of the following embodiments, the same parts are denoted by the same reference numerals, and redundant description will be omitted.

In addition, in the present specification and the drawings, a plurality of components having substantially the same functional configuration may be distinguished by attaching different numerals after the same reference numerals. For example, a plurality of configurations having substantially the same functional configuration are distinguished as servers 100₁ and 100₂ as necessary. However, in a case where it is not particularly necessary to distinguish each of a plurality of components having substantially the same functional configuration, only the same reference numeral is attached. For example, in a case where it is not necessary to particularly distinguish the servers 100₁ and 100₂, they are simply referred to as the server 100.

One or more embodiments (including examples and modifications) described below can each be implemented independently. On the other hand, at least some of the plurality of embodiments described below may be appropriately combined with at least some of other embodiments. The plurality of embodiments may include novel features different from each other. Therefore, the plurality of embodiments can contribute to solving different objects or problems, and can exhibit different effects.

### 1. OVERVIEW

The opportunities for telephone calls/online meetings (hereinafter, referred to as a group call) performed by a large number of people (for example, three or more persons) are increasing. In recent years, a group call system (also referred to as an online meeting system) having various functions has been developed. Furthermore, in recent years, a displayless communication device (alternatively, a communication device in which the user is not scheduled to constantly gaze at the display) has been developed which is assumed to be used for a wide range of applications including group calls (for example, leisure, work, and business scenes).

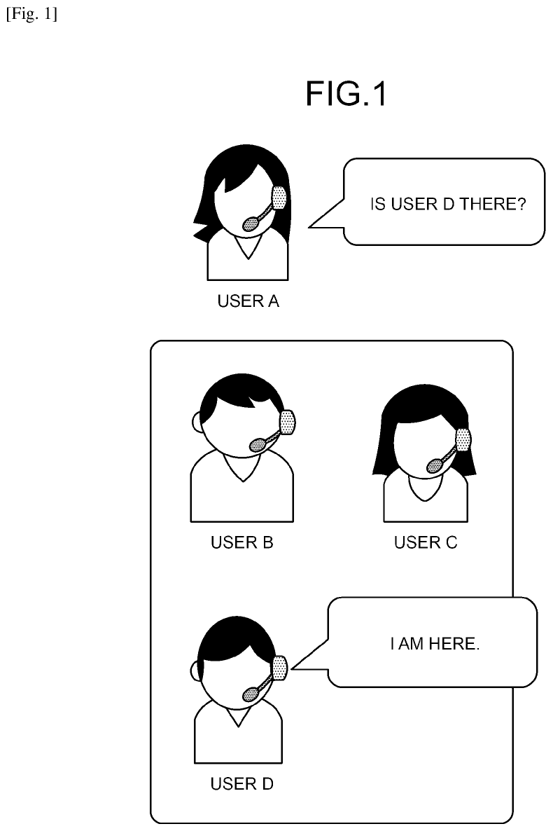

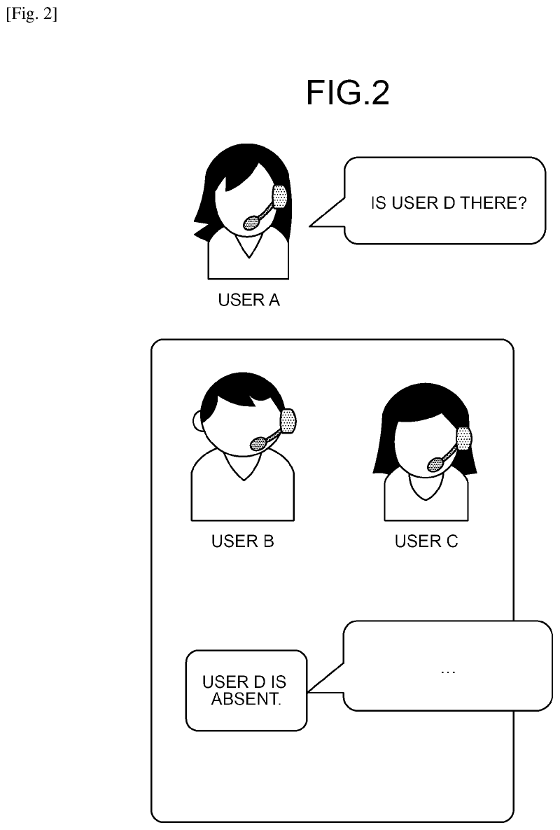

In a group call, there are many cases where it is difficult to grasp the state of another user. In a situation where it is difficult to grasp the state of another user, the group call may not be smoothly performed, for example, the group call is interrupted to grasp the state of another user. For example, consider a scene in which a certain user confirms participation (present)/non-participation (absent, absent) of another user in a group call. FIGS. 1 and 2 are diagrams for describing a problem of the present embodiment. In the examples of FIGS. 1 and 2, a user A confirms participation (present)/non-participation (absent, absent) of a user D in a group call. In the examples of FIGS. 1 and 2, the user A participates in the group call using a displayless communication device.

Since the user A participates in the group call using the displayless communication device, the user A determines whether or not the user D participates in the group call based on whether or not the user D has answered the call to the user D. In the example of FIG. 1, the user D participates in the group call. Therefore, the user A can immediately obtain the answer of the user D, and as a result, the user A can immediately determine that the user D participates in the group call.

On the other hand, when the user D does not participate in the group call as illustrated in FIG. 2, naturally, there is no answer from the user D. In this case, the user A has no choice but to determine that the user D is absent when there is no answer from the user D for a while, and as a result, it takes time to confirm the participation/non-participation in the group call. In particular, in a case where there are many absent persons, it takes an extremely long time to confirm participation/non-participation in the group call. In this case, the group call is not smoothly performed.

This problem is often found in a group call system (online meeting system) that can always display a list of participants of the group call. In a displayless communication device (Alternatively, the communication device in which the user is not scheduled to constantly gaze at the display), it is further required to solve this problem.

Therefore, the present embodiment solves the above problem as follows.

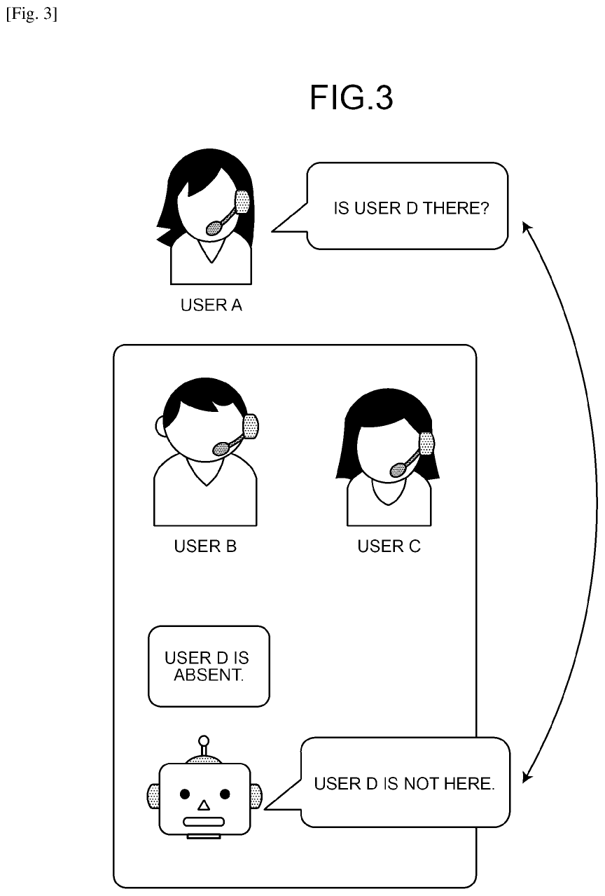

FIG. 3 is a diagram for explaining an example of a solution means of the present embodiment. The group call system of the present embodiment has a function of recognizing a voice of a user participating in a group call. In addition, the group call system of the present embodiment has a function of managing a state of a user participating in a group call.

First, the group call system acquires a voice of the user in the group call and recognizes content of the voice. The group call system discriminates whether or not the content of the recognized voice satisfies a predetermined criterion. For example, the group call system discriminates whether or not the content of the voice of a certain user participating in the group call is a call to another user participating in or planning to participate in the group call. When the content of the voice is a call to another user, the group call system further discriminates whether or not the another user is in a responsive state.

When the another user is not in a responsive state (for example, when absent), the group call system generates a reply (voice data) including a phrase associated with the state of the another user, and makes a reply on behalf of the another user. In the example of FIG. 3, since the user D called by the user A is absent, the group call system replies that the user D is absent.

Note that, when the another user participates in the call, for example, as illustrated in FIG. 1, a response of the another user to the call can be expected. Therefore, when it is determined that the another user participates in the group call, the group call system does not necessarily have to make a reply on behalf of the another user.

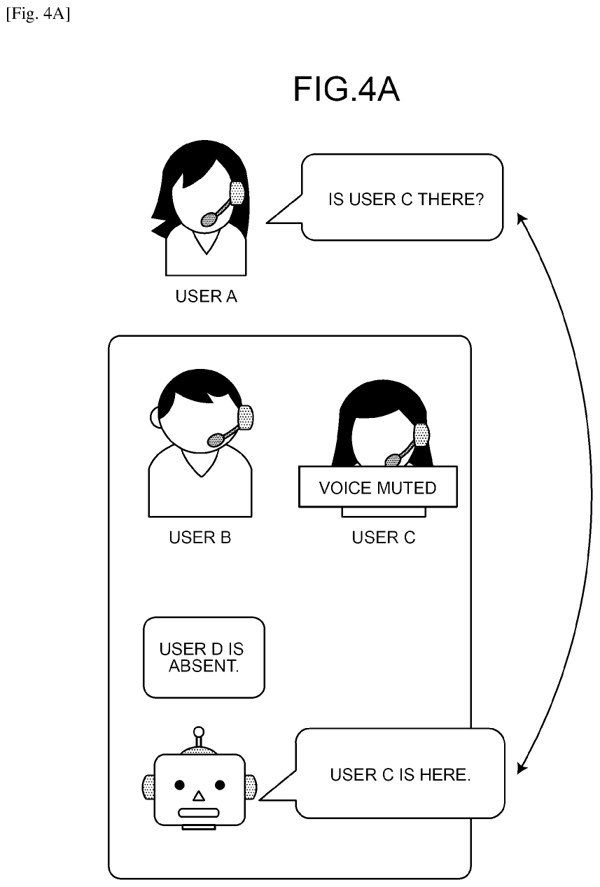

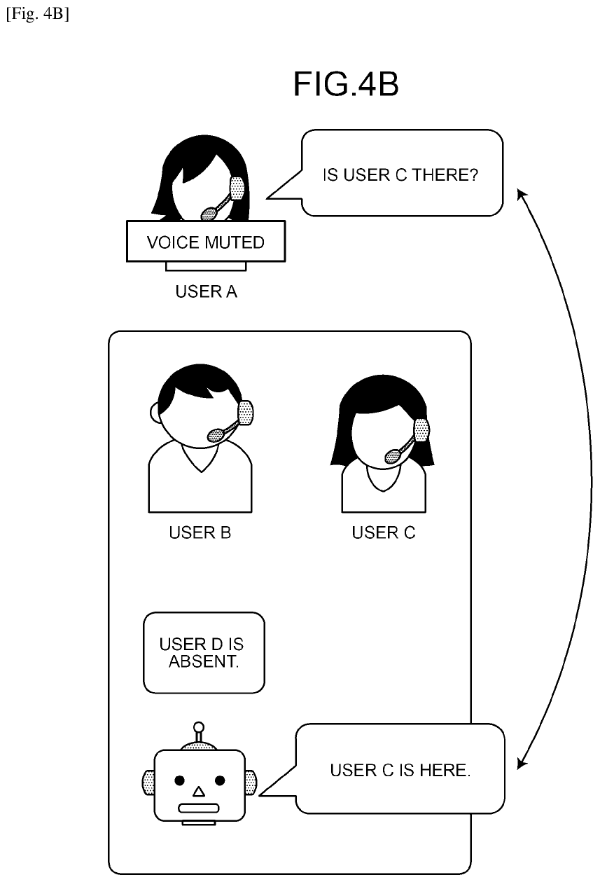

Note that, when another user who has been called is in a voice mute (microphone mute) state, it is naturally impossible to expect a response of the another user. In this case, the group call system may reply on behalf of the another user regardless of the current state of the another user. FIG. 4A is a diagram for explaining another example of the solution means of the present embodiment. In the example of FIG. 4A, the user C called by the user A is in a voice mute state. Therefore, in this case, the group call system may reply that the user C participates in the group call. The group call system may output that the user C is in a voice mute (microphone mute) state in addition to or in place of the response indicating that the user C participates in the group call.

Note that the group call system may reply depending on the state of the calling side user instead of the called side user. For example, when the user who has made a call is in a voice mute (microphone mute) state, naturally, the voice does not reach an opposite party, and thus, it is not possible to expect a response from another user who has made a call. Also in this case, the group call system may make a reply including a phrase associated with the state of the another user to the calling side user. FIG. 4B is a diagram for describing another example of the solution means of the present embodiment. In the example of FIG. 4B, the user A who has made a call is in a voice mute state. Furthermore, in the example of FIG. 4B, the user C to be called participates in the group call. Therefore, in this case, the group call system replies to the user A that the user C participates in the group call.

Note that, when the calling side user is in the voice mute state, the group call system may reply regardless of the current state of another user who is called. Furthermore, the group call system may reply only to the user who made a call (the user A in the example of FIG. 4B). When a user makes a call to another user after muting his/her microphone, the user who makes the call can confirm the participation/non-participation or the like of the another user without adding the voice of the call to the voice of the group call.

According to the present embodiment, when an opposite party to whom the participant of the group call wants to talk is not in a responsive state, the participant can quickly grasp that the opposite party is not in the responsive state. There is no need to perform absence confirmation by a method such as “waiting for a response from a called party for a while” performed in the conventional group call. As a result, the group call system can implement a smooth group call.

Although the outline of the present embodiment has been described above, the information processing system 1 according to the present embodiment will be described in detail below.

### 2. CONFIGURATION OF COMMUNICATION SYSTEM

First, a configuration of the information processing system 1 will be described.

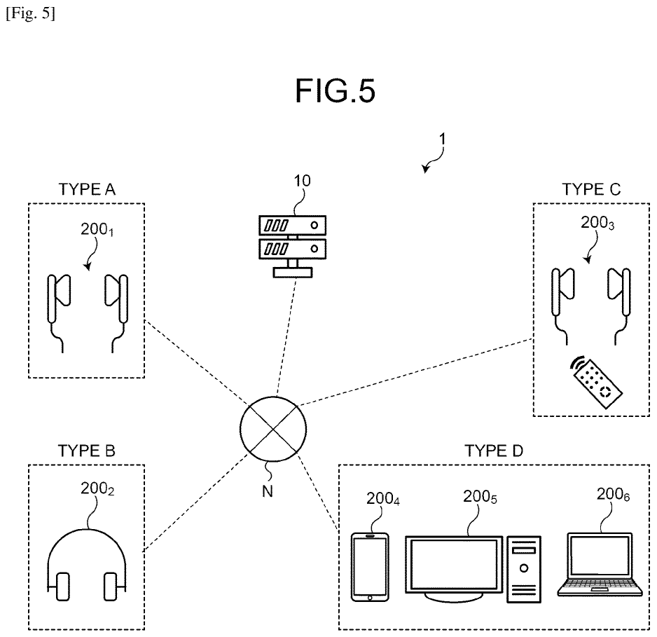

FIG. 5 is a diagram illustrating a configuration example of the information processing system 1 according to the embodiment of the present disclosure. The information processing system 1 includes a group call system 10 and a plurality of terminal devices 200. The group call system 10 is a system that manages group calls. The group call system 10 is disposed on a wide-area or closed-area network. In addition, the terminal device 200 is a communication device (user terminal) used for a group call. In the example of FIG. 5, the information processing system 1 includes terminal devices 200₁ to 200₆ as the terminal device 200. The group call system 10 and the terminal device 200 are connected via a network N.

Note that it is desirable that the group call system 10 be configured to manage not only whether or not the user participates in the group call but also whether or not the user is in an unresponsive state (a state in which the user participates in the group call but cannot respond). However, it is difficult for the group call system 10 and the terminal device 200 to estimate that the user is in the unresponsive state (For example, a state in which the user is moving or is in a public place.) with high accuracy. Therefore, it is desirable that the terminal device 200 include an input device that enables the user to actively set the reason for absence. Here, the input device may be an operation device including a button, a jog dial, a touch screen, a touch sensor, or the like, or may be a microphone that enables input of an utterance command. Of course, the input device is not limited thereto.

In the present embodiment, the terminal device 200 is classified into four types A to D based on the presence or absence of the input device or the type of the input device. Note that it is not always necessary to discriminate the type B/C/D from the viewpoint of the presence or absence of any physical input device that enables setting of the reason for absence of the user.

### (A) Type A

The terminal device 200 of type A is a communication device that does not have a device (for example, the operation device) for the user to set a reason for absence. For example, the terminal device 200 of type A is a wearable communication device (for example, an earphone/headphone type communication device) without an input device such as a button, a jog dial, or a touch sensor. Note that, even in the type A, the terminal device 200 may include a sensor for detecting the state of the user, such as a proximity sensor.

### (B) Type B

The terminal device 200 of type B is a wearable communication device equipped with an input device for setting a reason for absence of the user. For example, the terminal device 200 of type B is an earphone/headphone type communication device equipped with an input device such as a button, a jog dial, or a touch sensor.

### (C) Type C

The terminal device 200 of type C is a wearable communication device including a separate input device that can be used by the user to set a reason for absence. For example, the terminal device 200 of type C is an earphone/headphone type communication device used together with a remote controller including an input unit such as a button, a jog dial, or a touch sensor.

### (D) Type D

The terminal device 200 of type D is a non-wearable communication device including an input device for the user to set a reason for absence. For example, the terminal device 200 of type D is a communication device such as a smartphone or a personal computer (PC) having an input device such as a touch panel or a keyboard. The input device may be a device integrated with the terminal device 200, or may be a device separate from the main body of the terminal device 200.

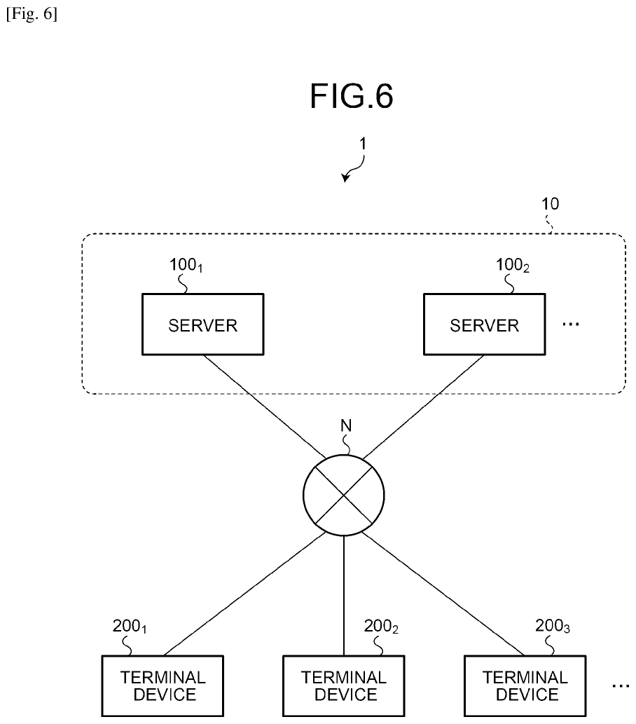

FIG. 6 is a diagram illustrating a specific configuration example of the information processing system 1. The information processing system 1 includes a group call system 10 including a server 100 and a terminal device 200. The information processing system 1 may include a plurality of servers 100 and a plurality of terminal devices 200. In the example of FIG. 6, the information processing system 1 includes servers 100₁ and 100₂ and the like as the server 100, and includes terminal devices 200₁, 200₂, and 200₃ and the like as the terminal device 200.

Note that, in the example of FIG. 6, a plurality of servers 100 are illustrated as the information processing device constituting the group call system 10, but the group call system 10 may be constituted by one server 100.

The server 100 and the terminal device 200 are connected via a network N. The network N is, for example, a communication network such as a local area network (LAN), a wide area network (WAN), a cellular network, a fixed telephone network, a regional Internet protocol (IP) network, or the Internet. The network N may include a wired network or a wireless network. In addition, the network N may include a core network. The core network is, for example, an evolved packet core (EPC) or a 5G core network (5GC). Of course, the network N may be a data network connected to the core network. The data network may be a service network of a communications carrier, for example, an IP Multimedia Subsystem (IMS) network. Furthermore, the data network may be a private network such as an intra-company network.

Although only one network N is illustrated in the example of FIG. 6, the number of networks to which the terminal device 200 can be connected is not limited to one. There may be a plurality of networks to which the terminal device 200 can be connected. For example, the terminal device 200 may be connectable to a cellular network and a wireless LAN network (for example, Wi-Fi (registered trademark)). Furthermore, the terminal device 200 may be connectable to a plurality of cellular networks with different communication carriers.

Note that the devices in the drawings may be considered as devices in a logical sense. That is, a part or all of the devices in the drawing may be realized by a virtual machine (VM), a container (Container), a docker (Docker), or the like, and they may be implemented on physically the same hardware.

Hereinafter, a configuration of each device constituting the information processing system 1 will be specifically described. Note that the configuration of each device described below is merely an example. The configuration of each device may be different from the following configuration.

### 2-1. Configuration Example of Server

First, a configuration example of the server 100 will be described.

The server 100 is an information processing device (computer) that performs various processing for implementing the group call. The server 100 may be an application server or a web server. Furthermore, the server 100 may be a PC server, a midrange server, or a mainframe server. Furthermore, the server 100 may be an information processing device that performs data processing (edge processing) near the user or the terminal. For example, the server 100 may be an information processing device (computer) provided side by side with or built in the base station. Of course, the server 100 may be an information processing device that performs cloud computing.

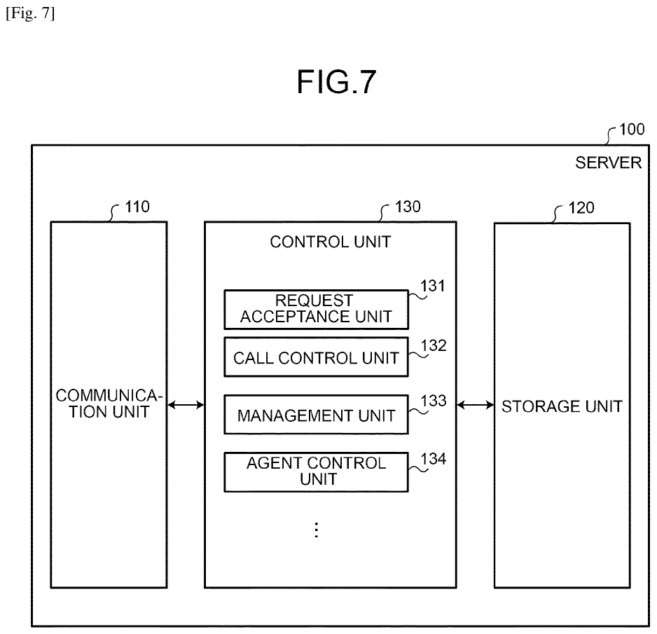

FIG. 7 is a diagram illustrating a configuration example of the server 100 according to the embodiment of the present disclosure. The server 100 includes a communication unit 110, a storage unit 120, and a control unit 130. Note that the configuration illustrated in FIG. 7 is a functional configuration, and the hardware configuration may be different from the functional configuration. Furthermore, the functions of the server 100 may be implemented in a distributed manner in a plurality of physically separated configurations. For example, the server 100 may include a plurality of information processing devices.

The communication unit 110 is a communication interface for communicating with other devices. For example, the communication unit 110 is a network interface. For example, the communication unit 110 is a local area network (LAN) interface such as a network interface card (NIC). The communication unit 110 may be a device connection interface such as a universal serial bus (USB). Note that the communication unit 110 may be a wired interface or a wireless interface. The communication unit 110 functions as a communication means of the server 100. The communication unit 110 communicates with an external device (for example, the terminal device 200 or another server 100) under the control of the control unit 130.

Note that, when the communication unit 110 includes a wireless interface, the communication unit 110 may be configured to connect to the network N using a wireless access technology such as LTE, NR, 6G Wi-Fi (registered trademark), or Bluetooth (registered trademark). At this time, the communication unit 110 may be configured to be able to use different wireless access technologies. For example, the communication unit 110 may be configured to be able to use NR and Wi-Fi. Furthermore, the communication unit 110 may be configured to be able to use different cellular communication technologies (for example, LTE and NR). In addition, the communication unit 110 may be connectable to the network N using a radio access technology other than LTE, NR, Wi-Fi, and Bluetooth.

The storage unit 120 is a data readable/writable storage device such as a dynamic random access memory (DRAM), a static random access memory (SRAM), a flash memory, or a hard disk. The storage unit 120 functions as a storage means of the server 100. The storage unit 120 stores, for example, identification information of the group call, information of the user who makes the group call, and information of the state of the user who makes the group call.

The control unit 130 is a controller that controls each unit of the server 100. The control unit 130 is implemented by, for example, a processor such as a central processing unit (CPU) or a micro processing unit (MPU). For example, the control unit 130 is implemented by a processor executing various programs stored in a storage device inside the server 100 using a random access memory (RAM) or the like as a work area. Note that the control unit 130 may be implemented by an integrated circuit such as an application specific integrated circuit (ASIC) or a field programmable gate array (FPGA). Furthermore, the control unit 130 may be implemented by a graphics processing unit (GPU). Any of the CPU, the MPU, the ASIC, the FPGA, and the GPU can be regarded as a controller.

As illustrated in FIG. 7, the control unit 130 includes a request acceptance unit 131, a call control unit 132, a management unit 133, and an agent control unit 134. Each block (the request acceptance unit 131 to the agent control unit 134) constituting the control unit 130 is a functional block indicating a function of the control unit 130. These functional blocks may be software blocks or hardware blocks. For example, each of the functional blocks described above may be one software module implemented by software (including microprograms), or may be one circuit block on a semiconductor chip (die). Of course, each functional block may be one processor or one integrated circuit. A configuration method of the functional block is arbitrary. Note that the control unit 130 may be configured by a functional unit different from the above-described functional block. The operation of the control unit 130 may be the same as the operation of each block of the control unit 230 of the terminal device 200.

### 2-2. Configuration Example of Terminal Device

Next, a configuration example of the terminal device 200 will be described.

The terminal device 200 is a communication device used by a user for a group call. For example, the terminal device 200 is a wearable communication device. As the terminal device 200, various types of information processing devices (computers) can be employed. For example, the terminal device 200 may be a headphone, a headset, or an earphone. Of course, the terminal device 200 is not limited thereto. For example, the terminal device 200 may be an intercommunication system (intercom) or a neck band speaker. Furthermore, the terminal device 200 may be a wearable device such as a smart watch.

Furthermore, the terminal device 200 may be an xR device such as an augmented reality (AR) device, a virtual reality (VR) device, or a mixed reality (MR) device. At this time, the xR device may be a glasses-type device such as AR glasses or MR glasses, or may be a head-mount-type device such as a VR head-mount display. In a case where the terminal device 200 is an xR device, the terminal device 200 may be a standalone-type device including only a user wearing portion (for example, the eyeglass portion). Furthermore, the terminal device 200 may be a terminal interlocking device including a user wearing portion (for example, the eyeglass portion) and a terminal portion (for example, a smart device) interlocked with the portion.

Furthermore, the terminal device 200 is not limited to a wearable communication device. For example, the terminal device 200 may be a stationary speaker. Furthermore, the sound output device may be a mobile terminal such as a personal computer, a mobile phone, a smart device (Smartphone or tablet), a personal digital assistant (PDA), or a notebook PC. Furthermore, the terminal device 200 may be a portable Internet of Things (IoT) device. Furthermore, the terminal device 200 may be a motorcycle, a moving relay vehicle, or the like on which communication equipment such as a field pickup unit (FPU) is mounted. Furthermore, the terminal device 200 may be an Internet of Things (IoT) device. In addition, any form of computer can be employed as the terminal device 200.

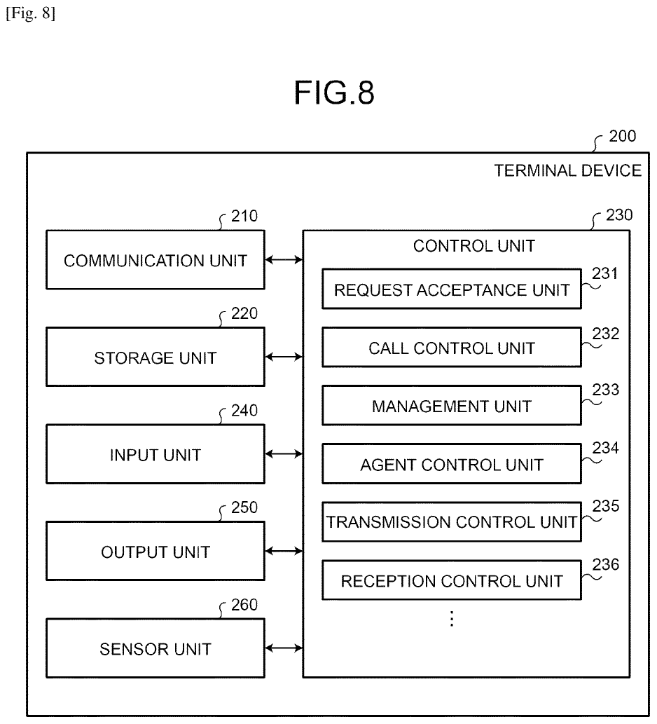

FIG. 8 is a diagram illustrating a configuration example of the terminal device 200 according to the embodiment of the present disclosure. The terminal device 200 includes a communication unit 210, a storage unit 220, a control unit 230, an input unit 240, an output unit 250, and a sensor unit 260. Note that the configuration illustrated in FIG. 8 is a functional configuration, and the hardware configuration may be different from the functional configuration. Furthermore, the functions of the terminal device 200 may be implemented in a distributed manner in a plurality of physically separated configurations. The terminal device 200 does not necessarily have all the following configurations. For example, the terminal device 200 does not have to include the sensor unit 260.

The communication unit 210 is a communication interface for communicating with other devices. For example, the communication unit 210 is a LAN interface such as Network Interface Card (NIC). The communication unit 210 may be a device connection interface such as a USB. Note that the communication unit 210 may be a wired interface or a wireless interface. The communication unit 210 communicates with an external device (for example, the server 100 or another terminal device 200) under the control of the control unit 230.

Note that, when the communication unit 210 includes a wireless interface, the communication unit 210 may be configured to connect to the network N using a wireless access technology such as LTE, NR, 6G Wi-Fi (registered trademark), or Bluetooth (registered trademark). At this time, the communication unit 210 may be configured to be able to use different wireless access technologies. For example, the communication unit 210 may be configured to be able to use NR and Wi-Fi. Furthermore, the communication unit 210 may be configured to be able to use different cellular communication technologies (for example, LTE and NR). In addition, the communication unit 210 may be connectable to the network N using a wireless access technology other than LTE, NR, Wi-Fi, and Bluetooth.

The storage unit 220 is a storage device capable of reading and writing data, such as a DRAM, an SRAM, a flash memory, or a hard disk. The storage unit 220 functions as a storage means of the terminal device 200.

The control unit 230 is a controller that controls each unit of the terminal device 200. The control unit 230 is implemented by, for example, a processor such as a CPU or an MPU. For example, the control unit 230 is implemented by a processor executing various programs stored in a storage device inside the terminal device 200 using a RAM or the like as a work area. Note that the control unit 230 may be implemented by an integrated circuit such as an ASIC or an FPGA. Furthermore, the control unit 230 may be implemented by a graphics processing unit (GPU). Any of the CPU, the MPU, the ASIC, the FPGA, and the GPU can be regarded as a controller.

As illustrated in FIG. 8, the control unit 230 includes a request acceptance unit 231, a call control unit 232, a management unit 233, an agent control unit 234, a transmission control unit 235, and a reception control unit 236. Each block (the request acceptance unit 231 to the reception control unit 236) constituting the control unit 230 is a functional block indicating a function of the control unit 230. These functional blocks may be software blocks or hardware blocks. For example, each of the functional blocks described above may be one software module implemented by software (including microprograms), or may be one circuit block on a semiconductor chip (die). Of course, each functional block may be one processor or one integrated circuit. The control unit 230 may be configured by a functional unit different from the above-described functional block. A configuration method of the functional block is arbitrary. The operation of the control unit 230 may be the same as the operation of each block of the control unit 130 of the server 100. In this case, the control unit 130 of the server 100 does not necessarily have to have the corresponding block (for example, the request acceptance unit 131, the call control unit 132, the management unit 133, and/or the agent control unit 134).

The input unit 240 is an input device that accepts various inputs from the outside. For example, the input unit 240 is an operation device for the user to perform various operations such as a button, a jog dial, a touch sensor, a keyboard, a mouse, and an operation key. Note that, when a touch panel or a touch screen is adopted as the terminal device 200, the touch panel or the touch screen is also included in the input unit 240. In this case, the user performs various operations by touching the screen with a finger or a stylus. Note that the input unit 240 may be a microphone that enables input of an utterance command.

The output unit 250 is a device that performs various outputs such as sound, light, vibration, and an image to the outside. The output unit 250 performs various outputs to the user under the control of the control unit 230. Note that the output unit 250 includes a display device that displays various types of information. The display device is, for example, a liquid crystal display or an organic electro luminescence display (for example, an organic light emitting diode (OLED) display). Note that the output unit 250 may be a touch panel type display device. In this case, the input unit 240 and the output unit 250 may be regarded as an integrated configuration. The output unit 250 may be an output unit of an xR device such as AR glasses. Note that, when the terminal device 200 is a displayless communication device, the terminal device 200 does not necessarily have to include the display device.

The sensor unit 260 is a detection device that detects the state of the user. For example, the sensor unit 260 is a detection device including a non-contact type sensor that detects an object in a non-contact manner. For example, the sensor unit 260 includes one or a plurality of proximity sensors (also referred to as a non-contact sensor), and detects an object located in the detection area. The proximity sensor may be an optical sensor or a capacitive sensor. The optical proximity sensor is a sensor that detects light reflected by an object. The capacitive proximity sensor is a sensor that detects a change in capacitance generated between an object and the sensor.

When the sensor unit 260 is a non-contact type, the sensor unit 260 may be a 2D sensor or a 3D sensor. When the sensor unit 260 is a 2D sensor, the detection area formed by the sensor unit 260 is a two-dimensional area, and when the sensor unit 260 is a 3D sensor, the detection area formed by the sensor unit 260 is a three-dimensional area.

The sensor unit 260 is not limited to the non-contact type. The sensor unit 260 may be a contact type detection device. In this case, the sensor unit 260 includes one or a plurality of touch sensors, and detects an object coming in contact with a predetermined place of the terminal device 200. When the terminal device 200 is a headphone type device, the predetermined place may be a side surface of the headphone (a surface opposite to the speaker surface). In addition, when the terminal device 200 is an earphone type device, the predetermined place may be a side surface of the earphone (a surface opposite to the speaker surface).

The sensor unit 260 may include one or a plurality of sensors that perform detection regarding the state of the terminal device 200. At this time, the sensor unit 260 may include, for example, one or a plurality of acceleration sensors. Furthermore, the sensor unit 260 may include one or a plurality of gyro sensors. Furthermore, the sensor unit 260 may include one or a plurality of geomagnetic sensors. The sensor unit 260 may include a motion sensor obtained by combining the plurality of types of sensors.

In addition, the sensor unit 260 may be a sensor that detects sound. For example, the sensor unit 260 may be a microphone or a microphone array. Furthermore, the sensor unit 260 may be a depth sensor (for example, LiDAR). Furthermore, the sensor unit 260 may be a global navigation satellite system (GNSS) sensor. The GNSS sensor may be a global positioning system (GPS) sensor, a global navigation satellite system (GLONASS) sensor, a Galileo sensor, or a quasi-zenith satellite system (QZSS) sensor.

### 2-3. Configuration Example of Group Call System

Next, a configuration example of the group call system 10 will be described.

The group call system 10 is a system that manages group calls. In the above described example, the group call system 10 includes one or a plurality of servers 100, but the group call system 10 may include one or a plurality of terminal devices 200. Furthermore, the group call system 10 may be a combination of one or a plurality of servers 100 and one or a plurality of terminal devices 200. The information processing device constituting the group call system 10 may include an information processing device other than the server 100 and the terminal device 200.

In a case where the group call system 10 includes a plurality of information processing devices, these information processing devices may cooperate to implement the functions (for example, the group call function) of the group call system 10. Note that, in a case where the group call system 10 includes a plurality of information processing devices, the plurality of information processing devices can be regarded as one information processing device (for example, one server) including a plurality of physically separated configurations (for example, a plurality of server devices). At this time, the plurality of physically separated configurations (for example, a plurality of server devices) may be located at remote locations.

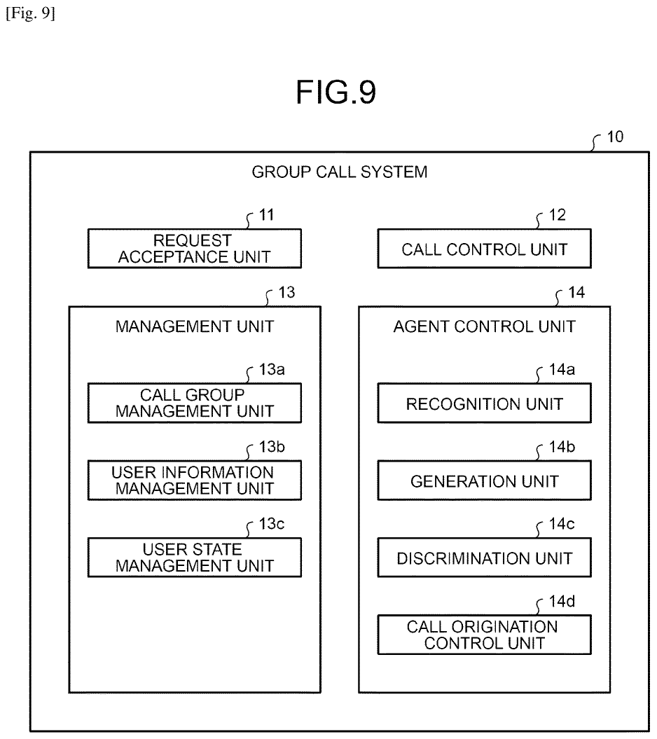

FIG. 9 is a diagram illustrating a configuration example of a group call system 10 according to the embodiment of the present disclosure. The group call system 10 includes a request acceptance unit 11, a call control unit 12, a management unit 13, and an agent control unit 14. Note that the configuration illustrated in FIG. 9 is a functional configuration, and the hardware configuration may be different from the functional configuration. Furthermore, the functions of the group call system 10 may be implemented in a distributed manner in a plurality of physically separated configurations.

The request acceptance unit 11 functions as an entrance of the group call system. In a case where the group call system 10 includes the server 100, the function of the request acceptance unit 11 is implemented by the request acceptance unit 131 of the server 100. In a case where the group call system 10 includes the terminal device 200, the function of the request acceptance unit 11 is implemented by the request acceptance unit 231 of the terminal device 200. In a case where the group call system 10 includes the server 100 and the terminal device 200, the function of the request acceptance unit 11 is implemented by cooperation of the request acceptance unit 131 and the request acceptance unit 231.

The call control unit 12 controls the group call. In a case where the group call system 10 includes one or a plurality of servers 100, the function of the call control unit 12 is implemented by the call control unit 132 of the server 100. In a case where the group call system 10 includes the terminal device 200, the function of the call control unit 12 is implemented by the call control unit 232 of the terminal device 200. In a case where the group call system 10 includes the server 100 and the terminal device 200, the function of the call control unit 12 is implemented by cooperation of the call control unit 132 and the call control unit 232.

The management unit 13 manages group calls. In a case where the group call system 10 includes one or a plurality of servers 100, the function of the management unit 13 is implemented by the management unit 133 of the server 100. In a case where the group call system 10 includes the terminal device 200, the function of the management unit 13 is implemented by the management unit 233 of the terminal device 200. In a case where the group call system 10 includes the server 100 and the terminal device 200, the function of the management unit 13 is implemented by cooperation of the management unit 133 and the management unit 233.

As illustrated in FIG. 9, the management unit 13 includes a call group management unit 13a, a user information management unit 13b, and a user state management unit 13c.

The call group management unit 13a manages call groups. The call group management unit 13a manages call group information (for example, group identification information, a prospective participant list, and the like.).

The user information management unit 13b manages user information. For example, the user information management unit 13b manages a name, a nickname, and the like of a user who participates/plans to participate in the group call. The user state management unit 13c manages the user state (for example, able to respond/unable to respond, etc.). The user state will be described later.

The agent control unit 14 generates a proxy response agent and controls the proxy response agent. The proxy response agent is, for example, an object (instance) that makes a reply on behalf of the user who cannot respond to the call. In a case where the group call system 10 includes one or a plurality of servers 100, the function of the agent control unit 14 is implemented by the agent control unit 134 of the server 100. In a case where the group call system 10 includes the terminal device 200, the function of the agent control unit 14 is implemented by the agent control unit 234 of the terminal device 200. In a case where the group call system 10 includes the server 100 and the terminal device 200, the function of the agent control unit 14 is implemented by cooperation of the agent control unit 134 and the agent control unit 234.

The agent control unit 14 includes a recognition unit 14a, a generation unit 14b, a discrimination unit 14c, and a call origination control unit 14d.

The recognition unit 14a recognizes the voice in the group call. The recognition unit 14a may be an AI function module that understands that a user's utterance is a call to another user.

The generation unit 14b generates a response message for making a response on behalf of the user. For example, in a case where the voice recognized by the recognition unit 14a is a call from a certain user to another user, the generation unit 14b synthesizes a response message according to the current state of the another user.

In addition, the discrimination unit 14c discriminates/monitors the state of the user participating in the group call. In order to enable discrimination/monitoring of the user state, the discrimination unit 14c may refer to the prospective participant list managed by the call group management unit 13a and grasp the user registered in the call group. Furthermore, in order to specify the user called by the utterer, the discrimination unit 14c may refer to the name, nickname, or the like of the user managed by the user information management unit 13b. In addition, the discrimination unit 14c may be configured to receive a notification of the user state and a change in the call group in which the user is participating from the user state management unit 13c existing on the group call system. Then, upon receiving the notification, the discrimination unit 14c may create and manage information on the state of each user in the group call.

The call origination control unit 14d reflects the response message generated by the generation unit 14b in the group call.

### 3. STATE TRANSITION

Although the configuration of the information processing system 1 has been described above, the user state managed by the group call system 10 will be described before describing the operation of the information processing system 1 in detail.

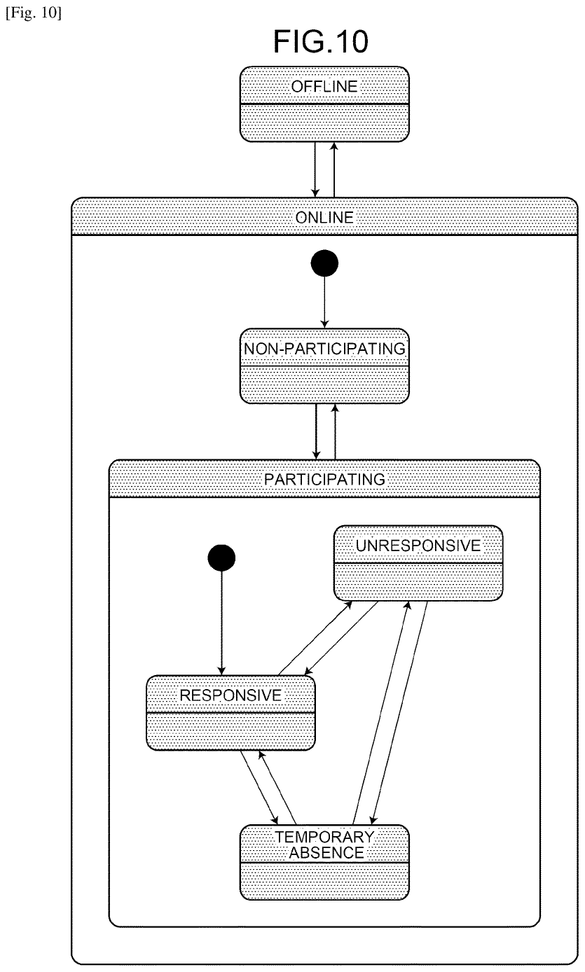

FIG. 10 is a state transition diagram illustrating transition of a user state in a group call. Note that the user state and transition illustrated in FIG. 10 are merely examples. The user state and transition of the present embodiment are not limited to the user state and transition illustrated in FIG. 10. In the following description, a group call in which the user participates or plan to participate may be referred to as a target group call.

The user state includes an offline state and an online state.

The offline state is a state in which the group call system 10 does not recognize that the corresponding user is connected to the group call system 10. For example, the offline state is a state in which the terminal device 200 of the corresponding user is not connected to the group call system 10 due to power off, non-connection to the Internet, or the like. Alternatively, the offline state is a state in which even when the terminal device 200 is connected to the group call system 10, the group call system 10 cannot recognize the connected terminal device 200 as that of the corresponding user. In a case where the user is called in the offline state, the group call system 10 makes a proxy response such as “Mr. D is offline.”.

The online state is a state other than the offline state. For example, the online state is a state in which the group call system 10 recognizes that the corresponding user is connected to the group call system 10. The online state includes a non-participation state and a participation state.

The non-participation state is a state in which the corresponding user does not participate in the target group call. In this state, there is a possibility that the corresponding user participates in response to the call. Therefore, when the user is called in this state, the group call system 10 makes a proxy response such as “Mr. D is not participating. Would you like to call?”. If the utterer wishes to do so, the system makes a call to the user on behalf of the utterer to encourage the user to participate in the group call.

The participation state is a state other than the non-participation state. For example, the participation state is a state in which the corresponding user participates in the target group call. The participation state includes a responsive state, an unresponsive state, and a temporary absence state.

The responsive state is a state in which the user is participating in the target group call and can respond to the call. In this state, the group call system 10 does not necessarily have to respond on behalf of the corresponding user.

The unresponsive state is a state in which the user is participating in the target group call and cannot respond. For example, the unresponsive state is a state in which the user is participating in the target group call but cannot speak even if the user is called due to moving or being in a public place. When the user is called in this state, the group call system 10 makes a proxy response such as “Mr. D cannot speak now.”. An input device (for example, a button operation or a voice command) provided in the terminal device 200 may be used for transition to this state or return to another state. The method of transitioning to the temporary unresponsive state/returning to another state is not limited to this example.

The temporary absence state is a state in which the user is participating in the target group call and is temporarily absent. For example, the temporary absence state is a state in which the user is participating in the target group call but cannot respond to the call due to a sudden visitor, home delivery receipt, or the like. When the user is called in this state, the group call system 10 makes a proxy response such as “Mr. D is currently not at his seat.”. For example, the terminal device 200 may transmit information based on a detection result of the sensor unit 260 (for example, a proximity sensor) to the group call system 10 as the information regarding the user state. Then, the group call system 10 may make the user state transition to the temporary absence state, for example, when it is recognized that the terminal device 200 (for example, an intercom) has been removed from the body of the user on the basis of the information regarding the user state. Furthermore, the group call system 10 may return the user state from the temporary absence state to another state (for example, the responsive state), for example, in a case of recognizing that the terminal device 200 (for example, an intercom) is re-worn on the body of the user on the basis of the information regarding the user state. The method of transitioning to the temporary absence state/returning to the another state is not limited to this example.

Note that the proxy response performed by the group call system 10 is not limited to one response per user state. The proxy response performed by the group call system 10 may have various variations. For example, the group call system 10 may change the response according to the situation of the user grasped by the group call system 10. For example, when the called user is in a non-participation state and the user participates in another group call managed by the group call system 10, a proxy response such as “Mr. D is participating in another call.” may be made.

Furthermore, the user state is not limited to the above. For example, the participation state may include a mute state. The mute state is a state in which the voice of the corresponding user is muted. For example, the mute state is a state in which the corresponding user disables the microphone (voice detection function) of the terminal device 200, or a state in which the corresponding user turns off the voice output in the group call using the function of the group call system 10. When the user is called in this state, the group call system 10 may make a proxy response such as “The sound of Mr. D is muted.”. Note that the mute state can be regarded as a kind of the unresponsive state or the temporary absence state.

### 4. OPERATION OF INFORMATION PROCESSING SYSTEM 1

The configuration of the information processing system 1 has been described above. Next, the operation of the information processing system 1 having such a configuration will be described.

### 4-1. Outline of Operation of Communication System

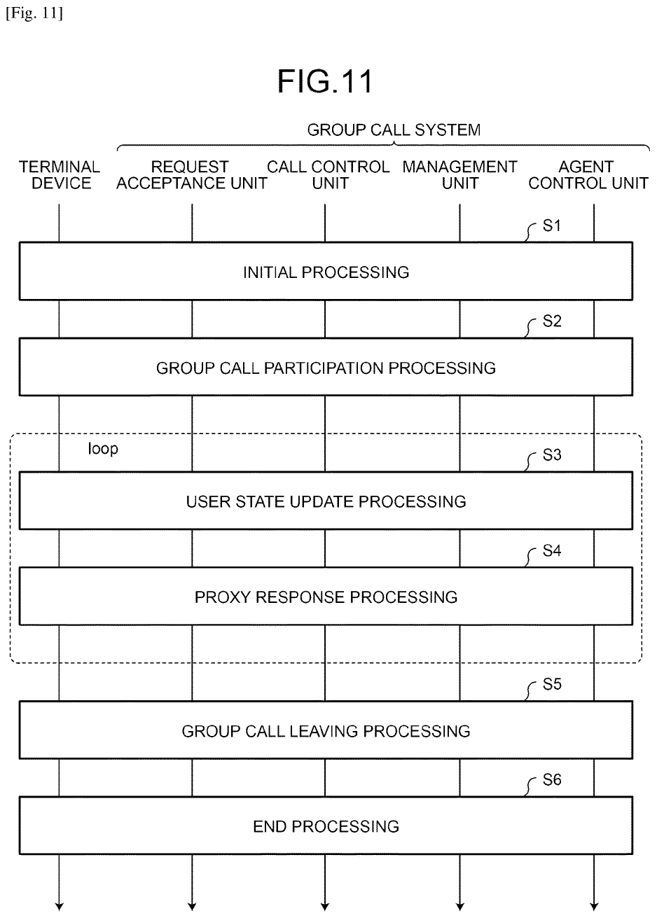

FIG. 11 is a sequence diagram for describing an outline of the operation of the information processing system 1. Hereinafter, an outline of an operation of the information processing system 1 will be described with reference to the sequence diagram of FIG. 11.

First, the terminal device 200 and the group call system 10 execute initial processing accompanying power ON or the like of the terminal device 200 (step S1). Thereafter, the terminal device 200 and the group call system 10 execute group call participation processing of the user who operates the terminal device 200 (step S2). When the group call participation processing is completed, the terminal device 200 and the group call system 10 repeat user state update processing and proxy response processing until the user of the terminal device 200 leaves the group call (Alternatively, until the group call is ended) (step S3, step S4). When the user of the terminal device 200 leaves the group call, the terminal device 200 and the group call system 10 execute group call leaving processing (step S5). The terminal device 200 and the group call system 10 execute end processing of the group call (step S6).

Hereinafter, the initial processing to the end processing will be described in detail. First, the initial processing (step S1), the group call participation processing (step S2), the user state update processing (step S3), the group call leaving processing (step S5), and the end processing (step S6) will be described. Thereafter, the proxy response processing (step S4) will be described.

Note that user information such as the name of the user, a nickname that may be used for a call, and authentication information is assumed to be set in advance before the user uses the group call system 10. Note that, in a case where it is difficult for the user to input various types of information because the terminal device 200 is not equipped with a display or a keyboard, the user may set the user information in the group call system 10 using another terminal device 200.

Furthermore, it is assumed that information of a call group in which the user is likely to participate is also created in advance before the user uses the group call system 10. In addition, it is assumed that information of other users expected to participate in the call group is also set in the group call system 10 in a state of being associated with the same group. Furthermore, the group call system 10 may be configured to be able to register a call group (Hereinafter, the group is referred to as a default call group.) used by the user by default.

In the following description, the group call system 10 may be simply referred to as a system.

### 4-2. Initial Processing

First, the initial processing in step S1 will be described.

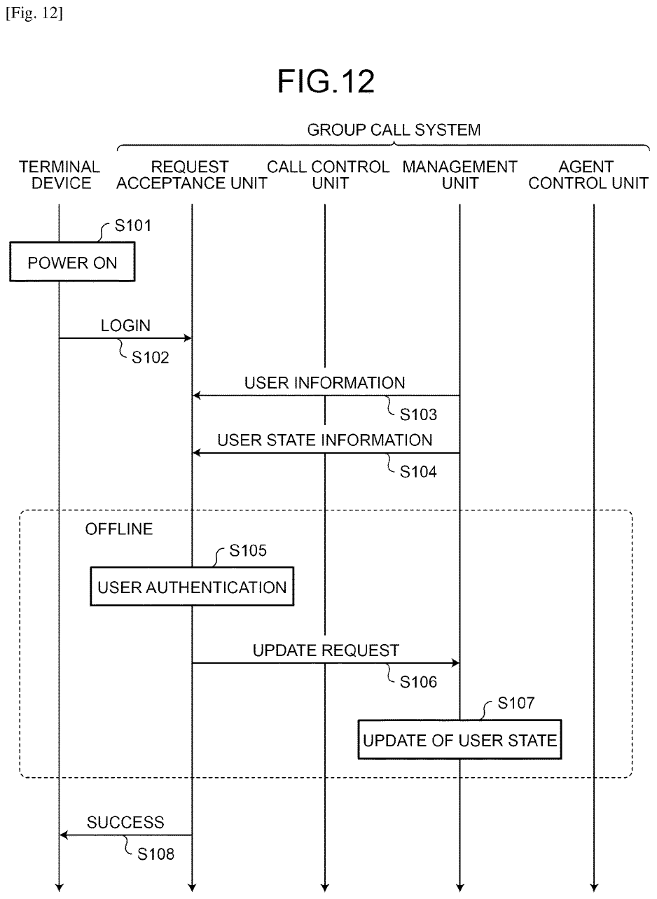

FIG. 12 is a sequence diagram illustrating an example of initial processing. The initial processing is various processing such as login processing performed prior to the processing of the group call. Hereinafter, the initial processing will be described with reference to the sequence diagram of FIG. 12.

First, the terminal device 200 performs start processing accompanying power on (step S101). When the start processing is completed, the terminal device 200 and the request acceptance unit 11 of the group call system 10 perform login processing of the user who operates the terminal device 200 (step S102).

After logging in, the request acceptance unit 11 acquires the user information from the management unit 13 (the user information management unit 13b) of the group call system 10 (step S103). Further, the request acceptance unit 11 acquires the user state information from the management unit 13 (the user state management unit 13c) of the group call system 10 (step S104). The user state information is information indicating a current state of the user.

When the user state information is already in the online state, the request acceptance unit 11 notifies the terminal device 200 of the login success (step S108), and ends the initial processing.

On the other hand, when the user state is the offline state, the request acceptance unit 11 performs user authentication on the basis of the user information or the like acquired in step S103 (step S105). Then, the request acceptance unit 11 requests the management unit 13 (user state management unit 13c) to update the user state (step S106). The management unit 13 (user state management unit 13c) updates the user state information to the online state (non-participation state) on the basis of the update request (step S107). When the update is completed, the request acceptance unit 11 notifies the terminal device 200 of the login success (step S108), and ends the initial processing.

### 4-3. Group Call Participation Processing

Next, the group call participation processing in step S2 will be described.

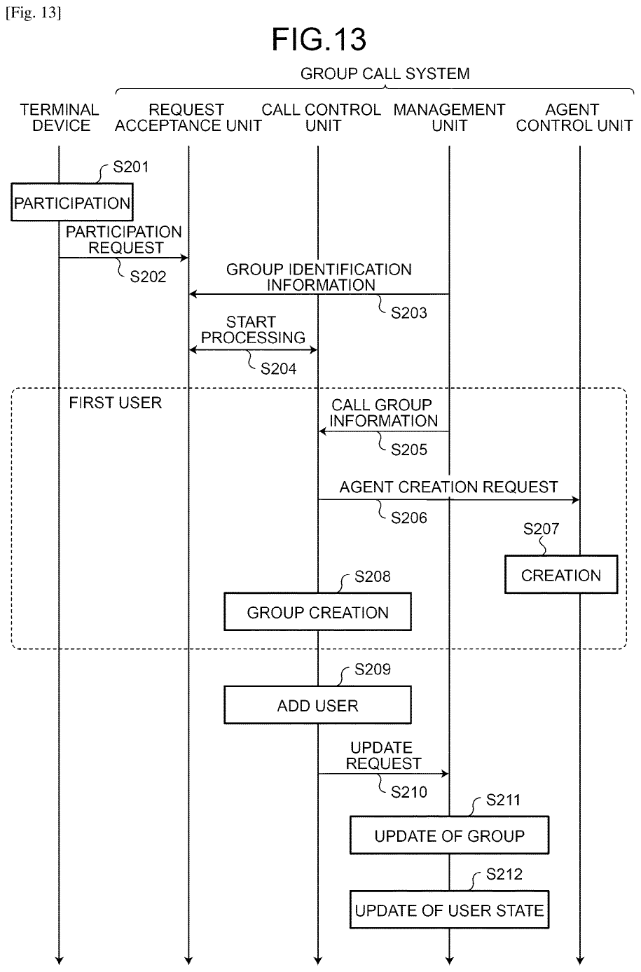

FIG. 13 is a sequence diagram illustrating an example of group call participation processing. The group call participation processing is processing performed when the user participates in the group call. Hereinafter, the group call participation processing will be described with reference to the sequence diagram of FIG. 13.

First, the terminal device 200 detects an operation of the user associated with the group call participation (step S201). Note that the group call system 10 may have a specification that allows the user to automatically participate in a default call group (Alternatively, the last specified call group in the previous use) after power on of the terminal device 200. In this case, the terminal device 200 can omit the processing of step S201. Of course, the group call system 10 may have a specification in which the user designates a call group to participate in a manual operation.

Subsequently, the terminal device 200 transmits a request for allowing the user to participate in the group call to the request acceptance unit 11 of the group call system 10 (step S202). In a case where the user designates the call group in which the user participates by manual operation, identification information of the call group in which the user participates may be transmitted together with this request.

Subsequently, the request acceptance unit 11 acquires the identification information of the call group in which the user plans to participate from the management unit 13 (user information management unit 13b) of the group call system 10 (step S203). For example, the request acceptance unit 11 may acquire, from the management unit 13, the identification information of the call group registered in the schedule of the system or the like as the participation schedule of the user. In addition, in a case where the group call system 10 has a specification that allows the user to automatically participate in a default call group (or the last specified call group) after power on of the terminal device 200, the request acceptance unit 11 may acquire the identification information of the default call group (or the last specified call group) from the management unit 13.

Subsequently, the request acceptance unit 11 and the call control unit 12 perform various processing associated with the start of the group call (step S204). For example, the call control unit 12 of the group call system 10 establishes a communication link used for the group call by the terminal device 200 on the basis of a request from the request acceptance unit 11.

Note that, when the user of the terminal device 200 is the first user who has accessed the call group, the call control unit 12 acquires information of the call group from the management unit 13 (call group management unit 13a) (step S205). Then, the call control unit 12 requests the agent control unit 14 of the group call system 10 to create a proxy response agent (step S206).

The agent control unit 14 creates a proxy response agent on the basis of the request from the call control unit 12 (step S207). The proxy response agent is, for example, an object (instance) that makes a reply on behalf of a user (For example, a user in the non-participation state/the unresponsive state/the temporary absence state/the mute state) who cannot respond to the call.

Then, the call control unit 12 creates a call group on the basis of the information acquired in step S205 (step S208). At this time, the call control unit 12 may associate the proxy response agent created in step S207 with the created call group.

Subsequently, the call control unit 12 adds the user to the group call (step S209), and requests the management unit 13 (call group management unit 13a) to update the information regarding the call group and the user state (step S210). The management unit 13 (user state management unit 13c) updates the information regarding the call group and the user state on the basis of the request from the call control unit 12 (step S211, step S212). For example, the management unit 13 performs update to the effect that the corresponding user has participated in the call group, and makes the state information of the corresponding user transition from the non-participation state to the participation state (responsive state).

### 4-4. User State Update Processing

Next, the user state update processing in step S3 will be described.

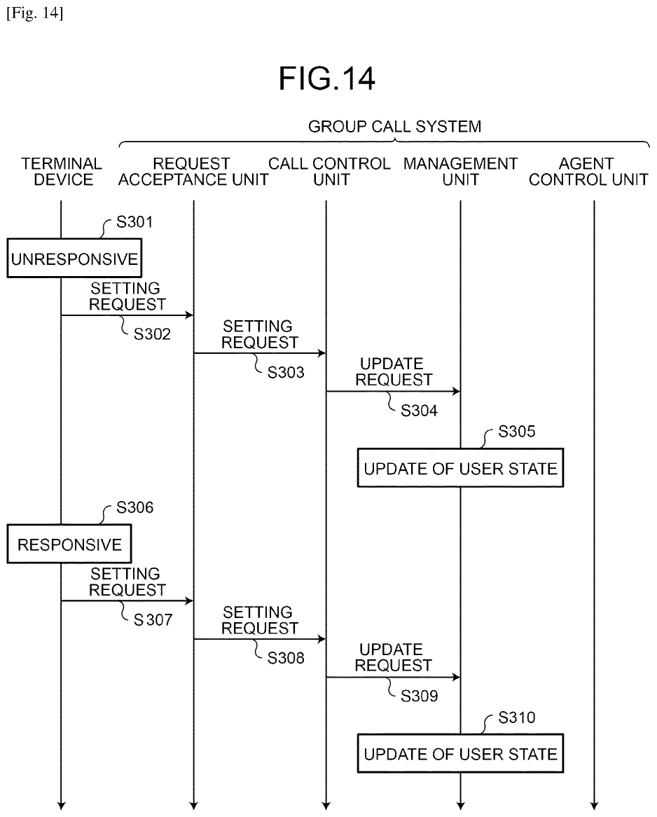

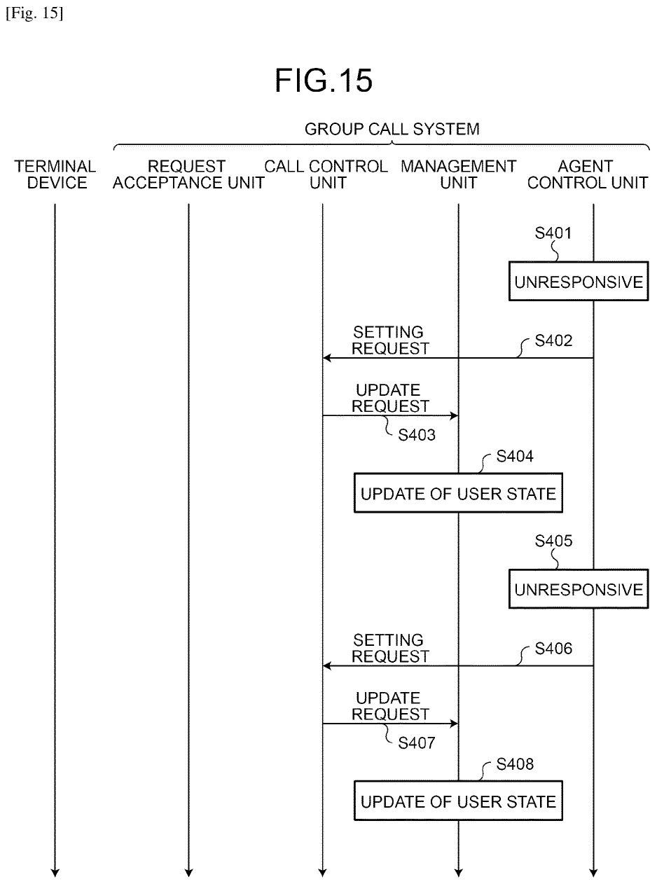

FIGS. 14 and 15 are sequence diagrams each illustrating an example of user state update processing. The user state update processing is processing for updating the user state information. The user state update processing is divided into (1) a case where the physical input device can be used for transition of the user state (hereinafter, referred to as a case 1) and (2) a case where the physical input device cannot be used for transition of the user state (hereinafter, referred to as a case 2).

### (1) Case 1

First, the case 1 will be described. The processing of Case 1 is applied, for example, in a case where the user cannot use a physical input device (for example, a button, a jog dial, a touch sensor, or the like) for transition of the user state. The processing of Case 1 is particularly applied to setting/releasing of the unresponsive state. Of course, the sequence of Case 1 may be applied to the setting/releasing of another state (for example, responsiveness, temporary absence, and the like).

FIG. 14 is a sequence diagram illustrating user state update processing according to Case 1. Hereinafter, the user state update processing according to the sequence example 1 will be described with setting/releasing of the unresponsive state as an example.

When the user cannot respond, the user performs a user operation for setting in the system that the user cannot respond. The user operation is, for example, an active input operation by the user using a physical input device such as a button, a jog dial, or a touch sensor. The terminal device 200 detects the user operation (step S301).

Subsequently, the terminal device 200 transmits information regarding the user state to the request acceptance unit 11 of the group call system 10. For example, the terminal device 200 transmits a setting request for making the user state transition to the unresponsive state to the request acceptance unit 11 (step S302). The request acceptance unit 11 transmits the setting request to the call control unit 12 (step S303).

The call control unit 12 transmits an update request of the user state to the management unit 13 (user state management unit 13c) on the basis of the received setting request (step S304). The management unit 13 (user state management unit 13c) updates the user state information to the unresponsive state on the basis of the update request (step S305).

When the user becomes a responsive state, the user performs a user operation for setting in the system that the user is in the responsive state. The user operation is, for example, an active input operation by the user using the input unit 240 of the terminal device 200. The terminal device 200 detects the user operation (step S306).

Subsequently, the terminal device 200 transmits a setting request for making the user state transition to the responsive state to the request acceptance unit 11 of the group call system 10 (step S307). The request acceptance unit 11 transmits the setting request to the call control unit 12 (step S308).

The call control unit 12 transmits an update request of the user state to the management unit 13 (user state management unit 13c) on the basis of the received setting request (step S309). The management unit 13 (user state management unit 13c) updates the user state information to the responsive state on the basis of the update request (step S310).

### (2) Case 2

Next, the case 2 will be described. As described above, the processing of Case 2 is applied, for example, in a case where the user cannot use the input device other than the microphone to set/release the user state.

In Case 2, the proxy response agent makes the user state transition. For example, the proxy response agent monitors the user's utterance transmitted to the group call system 10. The terminal device 200 transmits voice data including the information regarding the user state to the group call system 10. For example, the terminal device 200 transmits, to the group call system 10, voice data including a voice command for requesting setting/releasing of the user state (for example, the unresponsive state). When detecting a voice command requesting setting/releasing of the user state (for example, the unresponsive state) from the utterance, the proxy response agent makes the user state transition to a state corresponding to the voice command (for example, unresponsive state/responsive state) via the call control unit 12.

FIG. 15 is a sequence diagram illustrating user state update processing according to Case 2. Hereinafter, the user state update processing according to the sequence example 1 will be described with setting/releasing of the unresponsive state as an example. Note that the present sequence example may be applied to the setting/releasing of another state (for example, responsiveness, temporary absence, and the like).

The proxy response agent generated by the agent control unit 234 detects a voice command requesting setting/releasing of the unresponsive state from the user's utterance (step S401). The proxy response agent transmits a setting request for making the user state transition to the unresponsive state to the call control unit 12 (step S402).

The call control unit 12 transmits an update request of the user state to the management unit 13 (user state management unit 13c) on the basis of the received setting request (step S403). The management unit 13 (user state management unit 13c) updates the user state information to the unresponsive state on the basis of the update request (step S404).

The proxy response agent detects a voice command requesting setting/releasing of the responsive state from the user's utterance (step S405). The proxy response agent transmits, to the call control unit 12, a setting request for making the user state transition to the responsive state (step S406).

The call control unit 12 transmits an update request of the user state to the management unit 13 (user state management unit 13c) on the basis of the received setting request (step S407). The management unit 13 (user state management unit 13c) updates the user state information to the responsive state on the basis of the update request (step S408).

<<4-5. Group Call Leaving Processing>

Next, the group call leaving processing in step S5 will be described.

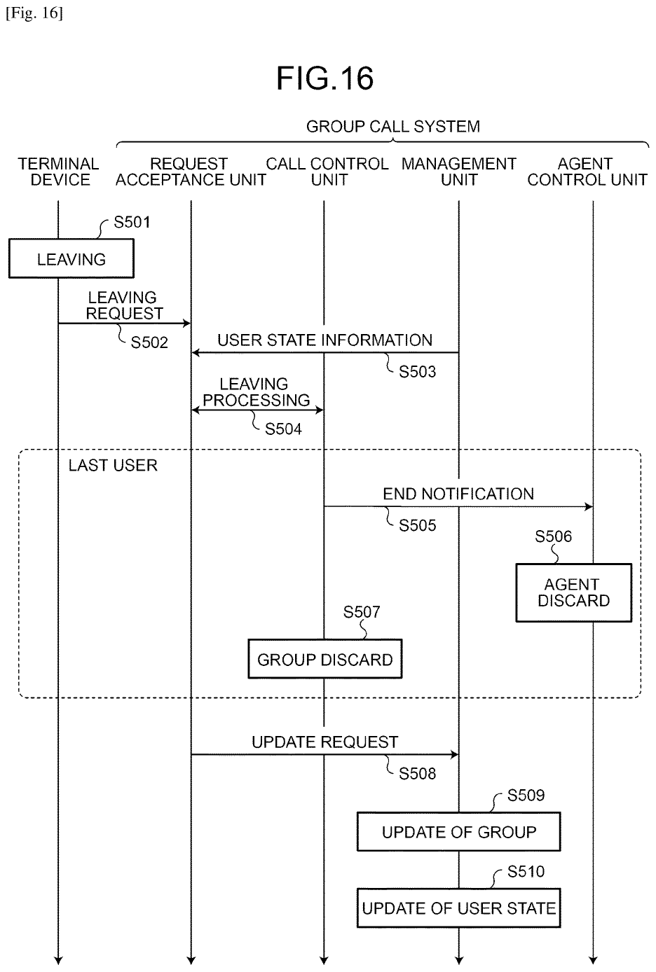

FIG. 16 is a sequence diagram illustrating an example of the group call leaving processing. The group call leaving processing is various processing performed when the group call ends. Hereinafter, the user state update processing will be described with reference to the sequence diagram of FIG. 16.

First, the terminal device 200 detects an operation of the user associated with leaving from the group call (step S501). The terminal device 200 transmits a request for making the user leave from the group call to the request acceptance unit 11 of the group call system 10 (step S502). The request acceptance unit 11 acquires the user state information of the user who is leaving from the management unit 13 (the user state management unit 13c) of the group call system 10 (step S503).

Subsequently, the request acceptance unit 11 and the call control unit 12 perform various processing associated with the user's leaving from the group call (step S504). For example, the call control unit 12 of the group call system 10 disconnects the communication link between the terminal device 200 and the group call system 10 on the basis of the request from the request acceptance unit 11.

Note that, in a case where the user who has left is the last user who has left the group call, the call control unit 12 notifies the agent control unit 14 of the end of the group call (step S505). Then, the agent control unit 14 discards the proxy response agent of the call group related to the end notification (step S506). Then, the call control unit 12 discards the group call (step S507). Note that, in a case where the user who has left is not the last user, the call control unit 12 does not notify the agent control unit 14 of the end and does not discard the group call, and only deletes the corresponding user from the call group.

Subsequently, the request acceptance unit 11 requests the management unit 13 (call group management unit 13a) to update the information regarding the call group and the user state (step S508). The management unit 13 (user state management unit 13c) updates the information regarding the call group and the user state on the basis of the request from the request acceptance unit 11 (step S509, step S510). For example, the management unit 13 performs update to the effect that the user has left the call group, and makes the user state information transition from the online state participation state (responsive state) to the online state non-participation state.

### 4-6. End Processing

Next, the end processing of step S6 will be described.

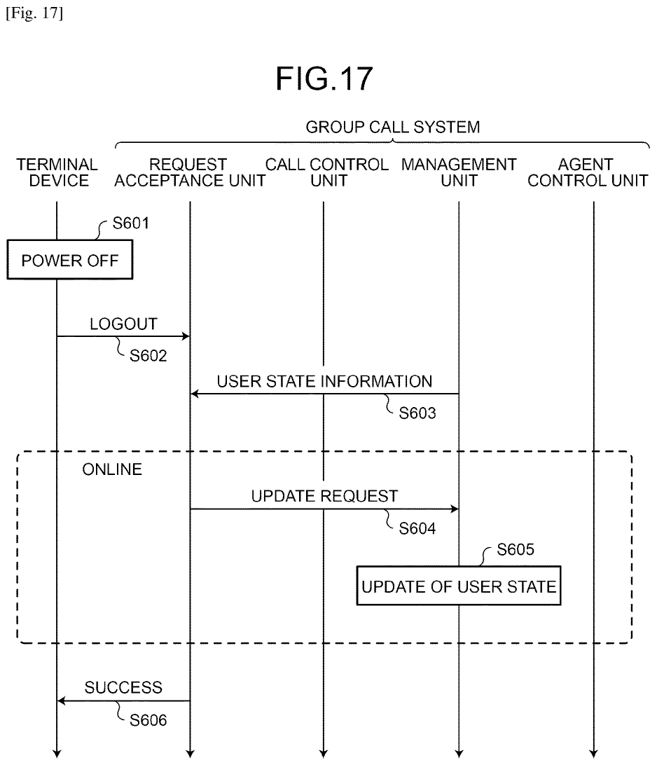

FIG. 17 is a sequence diagram illustrating an example of end processing. The end processing is processing for making the user leave from the group call. Hereinafter, the end processing will be described with reference to the sequence diagram of FIG. 17.

First, when the power off operation of the user is detected (step S601), the terminal device 200 and the request acceptance unit 11 of the group call system 10 perform logout processing of the user who operates the terminal device 200 (step S602).

After the logout, the request acceptance unit 11 acquires the user state information from the management unit 13 (the user state management unit 13c) of the group call system 10 (step S603).

In a case where the user state information is already in the offline state, the request acceptance unit 11 notifies the terminal device 200 of logout success (step S606), and ends the initial processing.

On the other hand, in a case where the user state is the online state, the request acceptance unit 11 requests the management unit 13 (user state management unit 13c) to update the user state (step S604). The management unit 13 (user state management unit 13c) updates the user state information to the offline state on the basis of the update request (step S605). When the update is completed, the request acceptance unit 11 notifies the terminal device 200 of the logout success (step S606), and ends the initial processing.

### 4-7. Proxy Response Processing

Next, proxy response processing in step S4 will be described.

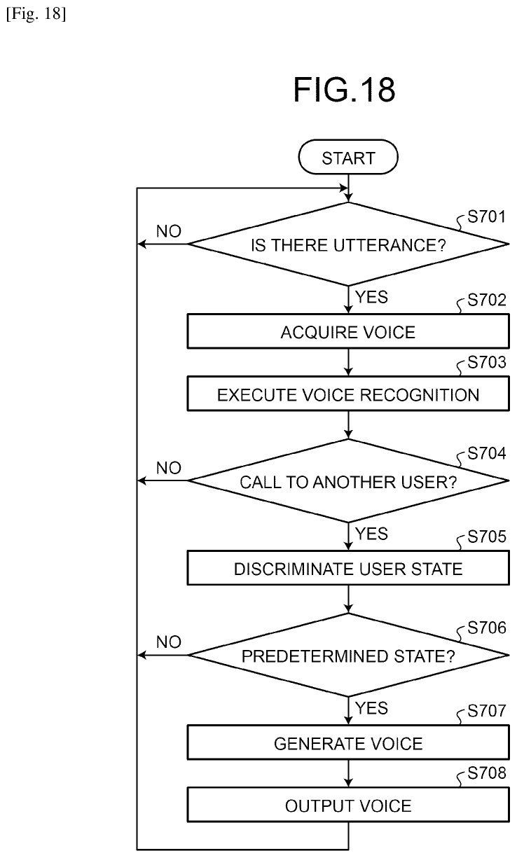

FIG. 18 is a flowchart illustrating an example of proxy response processing. The proxy response processing is processing for the system to respond on behalf of the user who cannot respond to the call. The proxy response processing is always executed while the group call is being executed. The proxy response processing is executed, for example, by the agent control unit 14 (recognition unit 14a, generation unit 14b, discrimination unit 14c, call origination control unit 14d) of the group call system 10. Hereinafter, the proxy response processing will be described with reference to the flowchart of FIG. 18.

The recognition unit 14a discriminates whether any one of a plurality of users participating in the group call has uttered (step S701). When there is no utterance (step S701: No), the recognition unit 14a repeats step S701 until the utterance is detected. When there is utterance, the recognition unit 14a acquires a voice of a user who has uttered (Hereinafter, the user is referred to as a first user.) in the group call (step S702). Then, the recognition unit 14a executes voice recognition of the acquired voice (step S703).

Subsequently, the discrimination unit 14c discriminates whether the recognized voice is a call to another user (Hereinafter, the user is referred to as a second user.) who participates in/plans to participate in the group call (step S704). When the recognized voice is not a call to the second user (step S704: No), the discrimination unit 14c returns the processing to step S701.

When the recognized voice indicates a call to the second user (step S704: Yes), the discrimination unit 14c discriminates the current state of the second user (step S705). For example, the discrimination unit 14c acquires the user state information of the second user from the management unit 13 (user state management unit 13c). Then, the discrimination unit 14c discriminates the current state of the second user on the basis of the acquired user state information. Note that the discrimination unit 14c may discriminate the current state of the first user in addition to the state of the second user. For example, the discrimination unit 14c may discriminate whether or not the current state of the first user is a mute state.

Subsequently, the discrimination unit 14c discriminates whether the state of the second user is a predetermined state other than the responsive state (step S706). The predetermined state may be an offline state, a non-participation state, an unresponsive state, or a temporary absence state. Further, the predetermined state may be a mute state. Note that the mute state can be regarded as a type of unresponsive state or temporary absence state.

Note that the group call system 10 may discriminate whether or not the second user is in a temporary absence state on the basis of a detection result of the sensor unit 260 (for example, a proximity sensor) included in the terminal device 200. For example, when the group call system 10 recognizes that the terminal device 200 (for example, an intercom) has been removed from the body of the second user on the basis of the detection result of the proximity sensor, the group call system 10 may update the user state information of the second user to the temporary absence state. Furthermore, for example, When the group call system 10 recognizes that the terminal device 200 (for example, an intercom) is re-worn on the body of the second user on the basis of the detection result of the proximity sensor, the group call system 10 may update the user state information of the second user from the temporary absence state to another state (for example, the responsive state). The discrimination unit 14c may discriminate whether or not the second user is in the temporary absence state on the basis of the user state information updated in this manner.

When the state of the second user is not the predetermined state (step S706: No), the discrimination unit 14c returns the processing to step S701.

When the state of the second user is the predetermined state (step S706: Yes), the generation unit 14b generates voice data including a phrase (hereinafter, referred to as a first phrase.) associated with the state of the second user (step S707). The voice or phrase (first phrase) generated here may be a voice or phrase indicating the state of the second user associated with the phrase. More specifically, the generated voice or phrase may be a combination of a voice or phrase indicating the state of the second user associated with the phrase and a voice or phrase identifying the second user. Furthermore, the generated voice or phrase may be different depending on the state of the second user.

### (1) Offline State

The offline state is a state in which the system does not recognize that the second user is connected to the system. When the state of the second user is the offline state, the generation unit 14b may generate, as voice data including the first phrase, voice data indicating that the terminal device 200 of the second user is not connected to the system. For example, the generation unit 14b may generate voice data such as “Mr. D is not currently online”. In this case, “Mr. D” corresponds to a voice or phrase that identifies the second user, and “is not currently online” corresponds to a voice or phrase indicating the state of the second user.

### (2) Non-Participation State

The non-participation state is a state in which the second user is online and a state in which the second user does not participate in the group call. When the state of the second user is the non-participation state, the generation unit 14b may generate voice data indicating that the second user does not participate in the group call as voice data including the first phrase. For example, the generation unit 14b may generate voice data such as “Mr. D does not participate.”. In this case, “Mr. D” corresponds to a voice or phrase that identifies the second user, and “does not participate” corresponds to a voice or phrase indicating the state of the second user.

Note that, when the state of the second user is the non-participation state and the second user participates in another group call managed by the group call system 10, voice data indicating that the second user is participating in another group call may be generated as voice data including the first phrase. For example, the generation unit 14b may generate voice data such as “Mr. D is participating in another call.”. In this case, “Mr. D” corresponds to a voice or phrase that identifies the second user, and “participating in another call” corresponds to a voice or phrase indicating the state of the second user.

Furthermore, when the state of the second user is the non-participation state, the generation unit 14b may generate voice data including a phrase (hereinafter, referred to as a second phrase) asking the first user whether or not to call the second user. More specifically, the generated voice or phrase (second phrase) may be a combination of a voice or phrase identifying the second user and a phrase asking the first user. For example, the generation unit 14b may generate voice data such as “Would you like to call Mr. D?”. In this case, “Mr. D” corresponds to a voice or phrase that identifies the second user, and “Would you like to call?” corresponds to a voice or phrase asking the first user. The voice data may include both the first phrase and the second phrase. For example, as a voice including the first phrase and the second phrase, the generation unit 14b may generate voice data such as “Mr. D is not participating. Would you like to call?”.

Note that, when the first user responds to the voice including the second phrase to call the second user, the call origination control unit 14d may make a call to request the second user to participate in the group call to the second user. For example, the call origination control unit 14d may notify the terminal device 200 of the second user of a request to participate in the group call (for example, push notification or e-mail transmission).

### (3) Unresponsive State

The unresponsive state is a state in which the second user is participating in the group call and cannot respond. When the state of the second user is the unresponsive state, the generation unit 14b may generate, as voice data including the first phrase, voice data indicating that the second user is in the unresponsive state. For example, the generation unit 14b may generate voice data such as “Mr. D currently cannot utter.”. In this case, “Mr. D” corresponds to a voice or phrase that identifies the second user, and “currently cannot utter” corresponds to a voice or phrase indicating the state of the second user.

### (4) Temporary Absence State

The temporary absence state is a state in which the second user is participating in the group call, and is temporarily absent. When the state of the second user is the unresponsive state, the generation unit 14b may generate voice data indicating that the second user is in the temporary absence state as voice data including the first phrase. For example, the generation unit 14b may generate voice data such as “Mr. D currently cannot utter.”. In this case, “Mr. D” corresponds to a voice or phrase that identifies the second user, and “currently cannot utter” corresponds to a voice or phrase indicating the state of the second user.

### (5) Mute State

The mute state is a state in which a user (for example, a first user or a second user) is participating in the group call and is voice-muted. The generation unit 14b may perform different processing between the case where the first user is in the mute state and the case where the second user is in the mute state. Of course, the generation unit 14b may perform the processing of step S707 only when the first user is in the mute state, or may perform the processing of step S707 only when the second user is in the mute state.

(Case where First User is in Mute State)

First, a case where the first user is in the mute state will be described. When the state of the first user is the mute state, the generation unit 14b may generate voice data indicating the current state of the second user as voice data including the first phrase. For example, the generation unit 14b may generate voice data such as “Mr. D is participating.” or “Mr. D is not participating.”. In this case, “Mr. D” corresponds to a voice or phrase that identifies the second user, and “participating” or “not participating” corresponds to a voice or phrase indicating the state of the second user.

Note that, when the state of the first user is the mute state, voice data including a phrase (hereinafter, referred to as a mute notification phrase) indicating that the voice of the first user is muted may be generated. For example, the generation unit 14b may generate voice data such as “The voice is muted.”.

(Case where Second User is in Mute State)

Next, a case where the second user is in the mute state will be described. When the state of the second user is the mute state, the generation unit 14b may generate voice data indicating that the second user is participating in the group call as voice data including the first phrase. For example, the generation unit 14b may generate voice data such as “Mr. D is participating.”.

Note that, when the state of the second user is the mute state, voice data including a phrase (hereinafter, referred to as a mute notification phrase) indicating that the voice of the second user is muted may be generated. For example, the generation unit 14b may generate voice data such as “The voice of Mr. D is muted.”. Note that the voice data including the mute notification phrase can also indicate that the second user is participating in the group call. Therefore, the voice data including the mute notification phrase can also be regarded as a type of voice data including the first phrase.

When the generation of the voice data is completed, the call origination control unit 14d outputs the voice data generated in step S707 to one or a plurality of users participating in the group call (step S708). Note that the call origination control unit 14d may output the voice data to all the users participating in the group call, or may output the voice data to only some of the users. For example, the call origination control unit 14d may output voice data only to the first user who has made a call. For example, when the first user is in the mute state, when the generation unit 14b generates voice data including the first phrase, the call origination control unit 14d may output voice including the first phrase only to the first user. The first user can confirm the participation/non-participation or the like of the first user without adding the voice of the call on the voice of the group call.

Note that, in a case where the second user is in the mute state, when the generation unit 14b generates voice data including the mute notification phrase, the call origination control unit 14d may output voice including the mute notification phrase only to the second user. It is possible to notify only the second user of being in the mute state without being known to other users.

According to the present embodiment, when the second user is not in the responsive state, another user participating in the group call can quickly grasp that the second user is not in the responsive state. As a result, the group call system can implement a smooth group call.

### 5. MODIFICATION

The above-described embodiments are examples, and various modifications and applications are possible.

### 5-1. Communication Quality Deterioration State

In the above-described embodiment, the offline state, the non-participation state, the responsive state, the unresponsive state, the temporary absence state, and the mute state are exemplified as the user state. However, the user state is not limited thereto.

For example, the user state may include a communication quality deterioration state. The communication quality deterioration state is a state in which it is difficult to respond due to deterioration in communication quality. More specifically, the communication quality deterioration state is a state in which the second user participates in the group call, and a state in which the quality of the communication link between the system and the terminal device 200 of the second user is lower than a predetermined criterion. Even in a case where the group call session is maintained between the group call system 10 and the terminal device 200 of the second user, when it is determined that the communication quality falls below the predetermined criterion, the discrimination unit 14c of the group call system 10 can discriminate that the user state is in the communication quality deterioration state.

When the state of the second user is the communication quality deterioration state, the generation unit 14b of the group call system 10 may generate, as voice data including the first phrase, voice data indicating that the communication quality of the second communication device is deteriorated. For example, the generation unit 14b may generate voice data such as “The quality of communication with Mr. D is deteriorated.”. Then, the call origination control unit 14d of the group call system 10 may output the generated voice data to one or a plurality of users participating in the group call.

### 5-2. Cooperation with Other Functions

In the above-described embodiment, when the state of the second user is the non-participation state, the group call system 10 makes a proxy call including the second phrase following the proxy response including the first phrase. The proxy response/proxy call performed by the group call system 10 may have other variations. For example, when the state of the second user is the non-participation state, the generation unit 14b of the group call system 10 may generate voice data including a phrase (first phrase/second phrase) of a non-participation cause such as “outside working hours” or “during long vacation” in cooperation with a schedule table service, for example. Then, the call origination control unit 14d of the group call system 10 may output the generated voice data to one or a plurality of users participating in the group call.

### 5-3. Call to all Users

In the group call system 10, a system equipped with the present function may have a list of prospective participants and grasp participants and non-participants of the group call. Then, when the recognized voice is a call to all the users who participate in or plan to participate in the group call, such as “Are you already?” or “Is everyone participating?”, the generation unit 14b of the group call system 10 may generate voice data including a phrase (hereinafter, referred to as a third phrase) associated with the state of one or a plurality of users who participate in or plan to participate in the group call.

At this time, as the voice data including the third phrase, the generation unit 14b may generate voice data including the names of all of the fewer of the participating users and the non-participating users. Note that, when the smaller number of the participating users or the non-participating users is larger than the predetermined number, the generation unit 14b may generate voice data including information on the number of persons of at least one of the participating users and the non-participating users as the voice data including the third phrase. For example, the generation unit 14b may generate, as the voice data including the third phrase, voice data such as “N people are participating” or “N people are not participating”. Then, the call origination control unit 14d of the group call system 10 may output the generated voice data to one or a plurality of users participating in the group call.

### 5-4. Other Modifications

The control device that controls the group call system 10, the server 100, or the terminal device 200 of the present embodiment may be implemented by a dedicated computer system or a general-purpose computer system.

For example, a communication program for executing the above-described operation is stored and distributed in a computer-readable recording medium such as an optical disk, a semiconductor memory, a magnetic tape, or a flexible disk. Then, for example, the program is installed in a computer, and the above-described processing is executed to configure the control device. At this time, the control device may be a device (for example, a personal computer) outside the group call system 10, the server 100, or the terminal device 200. Furthermore, the control device may be a device (for example, the control unit 130 or the control unit 230) inside the group call system 10, the server 100, or the terminal device 200.

In addition, the communication program may be stored in a disk device included in a server on a network such as the Internet so that the communication program can be downloaded to a computer. In addition, the above-described functions may be implemented by cooperation of an operating system (OS) and application software. In this case, a portion other than the OS may be stored in a medium and distributed, or a portion other than the OS may be stored in a server and downloaded to a computer.

Among the processing described in the above embodiments, all or a part of the processing described as being performed automatically can be performed manually, or all or a part of the processing described as being performed manually can be performed automatically by a known method. In addition, the processing procedure, specific name, and information including various types of data and parameters illustrated in the document and the drawings can be arbitrarily changed unless otherwise specified. For example, the various types of information illustrated in each figure are not limited to the illustrated information.

In addition, each component of each device illustrated in the drawings is functionally conceptual, and is not necessarily physically configured as illustrated in the drawings. That is, a specific form of distribution and integration of each device is not limited to the illustrated form, and all or a part thereof can be functionally or physically distributed or integrated in an arbitrary unit according to various loads, usage conditions, and the like. Note that this distributed or integrated configuration may be performed dynamically.

In addition, the above-described embodiments can be appropriately combined in a region in which the processing contents do not contradict each other. Furthermore, the order of each step illustrated in the flowchart and the sequence diagram of the above described embodiment can be changed as appropriate.

Furthermore, for example, the present embodiment can be implemented as any configuration constituting a device or a system, for example, a processor as a system large scale integration (LSI) or the like, a module using a plurality of processors or the like, a unit using a plurality of modules or the like, a set obtained by further adding other functions to a unit, or the like (that is, a configuration of a part of the device).

Note that, in the present embodiment, the system means a set of a plurality of components (devices, modules (parts), etc.), and it does not matter whether or not all the components are in the same housing. Therefore, a plurality of devices housed in separate housings and connected via a network and one device in which a plurality of modules are housed in one housing are both systems.

Furthermore, for example, the present embodiment can adopt a configuration of cloud computing in which one function is shared and processed by a plurality of devices in cooperation via a network.

### 6. CONCLUSION

As described above, according to an embodiment of the present disclosure, the group call system 10 recognizes the voice of the user who participates in the group call. In a case where the recognized voice satisfies the predetermined criterion, the group call system 10 generates voice data including a phrase associated with the state of one or more users who participate in or plan to participate in the group call. For example, in a case where the recognized voice is a call to another user who participates or plans to participate in the group call, and the another user is in a state (for example, an offline state, a non-participation state, an unresponsive state, a temporary absence state, or a mute state) different from the responsive state, the group call system 10 generates voice data including a phrase associated with the state of the another user. For example, the group call system 10 generates voice data such as “Mr. D is not participating”. Then, the group call system 10 outputs the generated voice data to one or a plurality of users participating in the group call.

As a result, when a party that the participant of the group call wants to talk to is not in the responsive state, the participant can quickly grasp that the party is not in the responsive state. As a result, the group call system 10 can implement a smooth group call.

Although the embodiments of the present disclosure have been described above, the technical scope of the present disclosure is not limited to the above-described embodiments as it is, and various modifications can be made without departing from the gist of the present disclosure. In addition, components of different embodiments and modifications may be appropriately combined.

Furthermore, the effects of each embodiment described in the present specification are merely examples and are not limited, and other effects may be provided.

Note that the present technology can also have the following configurations.

(1)

An information processing system comprising:
circuitry configured to
   acquire a voice corresponding to a first user of a first communication device in a group call;
   generate audio data including predetermined content indicating a state of one or more second users that participate in or are to participate in the group call; and
   output the audio data to at least the first communication device.
      (2)

The information processing system of (1), wherein
the circuitry is configured to generate the audio data by selecting the predetermined content from a plurality of predetermined phrases.
   (3)

The information processing system of any of (1) to (2), wherein
the first communication device does not include a display.
   (4)

The information processing system of any of (1) to (3), wherein the circuitry is configured to:
recognize that the acquired voice corresponds to a callout to a second user of a second communication device of the group call;
generate the audio data including a first phrase associated with a first state of the second user when the acquired voice corresponds to the callout of the second user and the second user is unable to respond; and
output the audio data including the first phrase to at least the first communication device.
   (5)

The information processing system of any of (1) to (4), wherein
the first state includes a state in which the second user is not connected to the group call; and
the first phrase indicates that the second user is not connected to the group call.
   (6)

The information processing system of any of (1) to (5), wherein
the first state includes a state that the second communication device is connected to a system for managing the group call and the second user is not participating in the group call, and
the circuitry is configured to generate, as the audio data including the first phrase, audio data indicating that the second user does not participate in the group call.
   (7)

The information processing system of any of (1) to (6), wherein
the first state includes a state that the second communication device is connected to a system for managing the group call and the second user is participating in another group call, and
the circuitry is configured to generate, as the audio data including the first phrase, audio data indicating that the second user is participating in another group call.
   (8)

The information processing system of (6) to (7), wherein
the circuitry is configured to generate audio data including a second phrase prompting the first user to request a response from the second user.
   (9)

The information processing system of (8), wherein
the circuitry is configured to generate a callout requesting the second user to participate in the group call in a case that the first user responds to the second phrase.
   (10)

The information processing system of any of (1) to (9), wherein
the first state includes a state in which the second user has joined the group call and is unable to respond, and
the circuitry is configured to generate, as the audio data including the first phrase, audio data indicating that the second user is unable to respond.
   (11)

The information processing system of any of (1) to (10), wherein
the first state includes a state in which the second user has joined the group call and is temporarily unavailable, and
the circuitry is configured to generate, as the audio data including the first phrase, audio data indicating that the second user is temporarily unavailable.
   (12)

The information processing system of any of (1) to (11), wherein
the second communication device is a wearable device including a proximity sensor, and
the circuitry is configured to determine whether the second user has joined the group call and is temporarily unavailable based on a detection result of a proximity sensor included in the second communication device.
   (13)

The information processing system of any of (1) to (12), wherein
the first state includes a state in which the second user has joined the group call and is voice-muted, and
the circuitry is configured to generate, as the audio data including the first phrase, audio data indicating that the second user is voice-muted.
   (14)

The information processing system of any of (1) to (13), wherein
the circuitry is configured to generate, as the audio data, audio data including a phrase indicating a state of a second user when the acquired voice corresponds to a callout to the second user and the first user is in a voice-mute state; and
output the audio data including the first phrase only to the first communication device.
   (15)

The information processing system of any of (1) to (14), wherein
the first state includes a state in which the second user has joined the group call and a quality of a communication link of the second communication device is lower than a predetermined criterion, and
the circuitry is configured to generate, as the audio data including the first phrase, audio data indicating that the quality of the communication link of the second communication device is lower than the predetermined criterion.
   (16)

The information processing system of any of (1) to (15), wherein the circuitry is configured to:
recognize that the acquired voice corresponds to a callout to a plurality of the one or more second users that participate in the group call;
generate, as the audio data including the first phrase, audio data corresponding to states of one or a plurality of users who participate in or plan to participate in the group call.
   (17)

The information processing system of (16), wherein
the circuitry is configured to generate audio data including names of at least one of participating users and non-participating users of the group call.
   (18)

The information processing system of (17), wherein
the circuitry is configured to generate audio data indicating a number of at least one of participating users and non-participating users of the group call.
   (19)

An information processing method comprising:
acquiring a voice corresponding to a first user of a first communication device in a group call;
generating audio data including predetermined content indicating a state of one or more second users that participate in or are to participate in the group call; and
outputting the audio data to at least the first communication device.
   (20)

One or more non-transitory computer-readable media including computer-program instructions, which when executed by an information processing system, cause the system to:
acquire a voice corresponding to a first user of a first communication device in a group call;
generate audio data including predetermined content indicating a state of one or more second users that participate in or are to participate in the group call; and
output the audio data to at least the first communication device.
   (21)

An information processing device comprising:
circuitry configured to
   capture voice data corresponding to a first user of the information processing device participating in a group call;
   transmit the captured voice data to a system remote from the information processing device;
   receive, from the system, audio data including predetermined content indicating a state of one or more second users that participate in or are to participate in the group call; and
   output the audio data received from the system.

### REFERENCE SIGNS LIST

1 Information processing system
10 Group call system
100 Server
200 Terminal device
110, 210 Communication unit
120, 220 Storage unit
130, 230 Control unit
240 Input unit
250 Output unit
260 Sensor unit
11, 131, 231 Request acceptance unit
12, 132, 232 Call control unit
13, 133, 233 Management unit
14, 134, 234 Agent control unit
235 Transmission control unit
236 Reception control unit
13a Call group management unit
13b User information management unit
13c User state management unit
14a Recognition unit
14b Generation unit
14c Discrimination unit
14d Call origination control unit
N Network

1. An information processing system comprising:
circuitry configured to
acquire a voice corresponding to a first user of a first communication device in a group call;
generate audio data including predetermined content indicating a state of one or more second users that participate in or are to participate in the group call; and
output the audio data to at least the first communication device.

2. The information processing system of claim 1, wherein
the circuitry is configured to generate the audio data by selecting the predetermined content from a plurality of predetermined phrases.

3. The information processing system of claim 1, wherein
the first communication device does not include a display.

4. The information processing system of claim 1, wherein the circuitry is configured to:
recognize that the acquired voice corresponds to a callout to a second user of a second communication device of the group call;
generate the audio data including a first phrase associated with a first state of the second user when the acquired voice corresponds to the callout of the second user and the second user is unable to respond; and
output the audio data including the first phrase to at least the first communication device.

5. The information processing system of claim 4, wherein
the first state includes a state in which the second user is not connected to the group call; and
the first phrase indicates that the second user is not connected to the group call.

6. The information processing system of claim 4, wherein
the first state includes a state that the second communication device is connected to a system for managing the group call and the second user is not participating in the group call, and
the circuitry is configured to generate, as the audio data including the first phrase, audio data indicating that the second user does not participate in the group call.

7. The information processing system of claim 4, wherein
the first state includes a state that the second communication device is connected to a system for managing the group call and the second user is participating in another group call, and
the circuitry is configured to generate, as the audio data including the first phrase, audio data indicating that the second user is participating in another group call.

8. The information processing system of claim 6, wherein
the circuitry is configured to generate audio data including a second phrase prompting the first user to request a response from the second user.

9. The information processing system of claim 8, wherein
the circuitry is configured to generate a callout requesting the second user to participate in the group call in a case that the first user responds to the second phrase.

10. The information processing system of claim 4, wherein
the first state includes a state in which the second user has joined the group call and is unable to respond, and
the circuitry is configured to generate, as the audio data including the first phrase, audio data indicating that the second user is unable to respond.

11. The information processing system of claim 4, wherein
the first state includes a state in which the second user has joined the group call and is temporarily unavailable, and
the circuitry is configured to generate, as the audio data including the first phrase, audio data indicating that the second user is temporarily unavailable.

12. The information processing system of claim 11, wherein
the second communication device is a wearable device including a proximity sensor, and
the circuitry is configured to determine whether the second user has joined the group call and is temporarily unavailable based on a detection result of a proximity sensor included in the second communication device.

13. The information processing system of claim 4, wherein
the first state includes a state in which the second user has joined the group call and is voice-muted, and
the circuitry is configured to generate, as the audio data including the first phrase, audio data indicating that the second user is voice-muted.

14. The information processing system of claim 1, wherein
the circuitry is configured to generate, as the audio data, audio data including a phrase indicating a state of a second user when the acquired voice corresponds to a callout to the second user and the first user is in a voice-mute state; and
output the audio data including the first phrase only to the first communication device.

15. The information processing system of claim 4, wherein
the first state includes a state in which the second user has joined the group call and a quality of a communication link of the second communication device is lower than a predetermined criterion, and
the circuitry is configured to generate, as the audio data including the first phrase, audio data indicating that the quality of the communication link of the second communication device is lower than the predetermined criterion.

16. The information processing system of claim 1, wherein the circuitry is configured to:
recognize that the acquired voice corresponds to a callout to a plurality of the one or more second users that participate in the group call;
generate, as the audio data including the first phrase, audio data corresponding to states of one or a plurality of users who participate in or plan to participate in the group call.

17. The information processing system of claim 16, wherein
the circuitry is configured to generate audio data including names of at least one of participating users and non-participating users of the group call.

18. The information processing system of claim 17, wherein
the circuitry is configured to generate audio data indicating a number of at least one of participating users and non-participating users of the group call.

19. An information processing method comprising:
acquiring a voice corresponding to a first user of a first communication device in a group call;
generating audio data including predetermined content indicating a state of one or more second users that participate in or are to participate in the group call; and
outputting the audio data to at least the first communication device.

20. One or more non-transitory computer-readable media including computer-program instructions, which when executed by an information processing system, cause the system to:
acquire a voice corresponding to a first user of a first communication device in a group call;
generate audio data including predetermined content indicating a state of one or more second users that participate in or are to participate in the group call; and
output the audio data to at least the first communication device.

21. An information processing device comprising:
circuitry configured to
capture voice data corresponding to a first user of the information processing device participating in a group call;
transmit the captured voice data to a system remote from the information processing device;
receive, from the system, audio data including predetermined content indicating a state of one or more second users that participate in or are to participate in the group call; and
output the audio data received from the system.
